(19) United States
(12) Patent Application Publication
(10) Pub. No.: US 2010/0247851 A1
(43) Pub. Date: Sep. 30, 2010

(54) SEALING MATERIAL FOR HONEYCOMB STRUCTURE, HONEYCOMB STRUCTURE, AND METHOD FOR MANUFACTURING HONEYCOMB STRUCTURE

(75) Inventors: Akikazu MIYATA, Ibi-gun (JP); Masanori KANAI, Ibi-gun (JP)

Correspondence Address: Ditthavong Mori & Steiner, P.C., 918 Prince Street, Alexandria, VA, 22314, US

(73) Assignee: IBIDEN CO., LTD., Ogaki-shi (JP)

(21) Appl. No.: 12/709,519

(22) Filed: Feb. 22, 2010

(30) Foreign Application Priority Data
Mar. 30, 2009 (JP) PCT/JP2009/056532

(51) Int. Cl. B32B 3/12; C09D 1/00; B05D 3/02; B32B 37/12

(52) U.S. Cl. 428/116; 106/286.8; 106/286.6; 106/286.7; 106/286.5; 106/286.1; 106/286.2; 106/286.3; 106/286.4; 427/314; 156/89.22

(57) ABSTRACT

A sealing material for a honeycomb structure includes inorganic fibers, inorganic particles, and an ion adsorbent. The inorganic fibers include a biosoluble inorganic compound. The ion adsorbent is in an amount of about 0.1% by weight or more.

### CROSS-REFERENCE TO RELATED APPLICATIONS

The present application claims priority under 35 U.S.C. §119 to PCT Application No. PCT/JP2009/056532, filed Mar. 30, 2009, the contents of which are incorporated herein by reference in their entirety.

### BACKGROUND OF THE INVENTION

1. FIELD OF THE INVENTION

The present invention relates to a sealing material for a honeycomb structure, a honeycomb structure, and a method for manufacturing a honeycomb structure.

2. DISCUSSION OF THE BACKGROUND

Honeycomb structures have been used as a filter for removing particulates and the like from exhaust gases discharged from an internal combustion engine such as a diesel engine or as a catalyst supporting carrier for converting toxic components such as HC (hydrocarbon) and CO (carbon monoxide) from exhaust gases. Inorganic fibers have been used as materials for various constituent members in a honeycomb structure. Specifically, for example, there have been used sealing material containing inorganic fibers, such as a sealing material (adhesive) for combining a plurality of honeycomb fired bodies to construct a ceramic block and a sealing material (also referred to as peripheral sealing material or peripheral coating material) to be applied on the periphery of the ceramic block.

In the case where such inorganic fibers are taken into human body, especially in the lung, and remain there for a long time, the inorganic fibers might be harmful to human body. Therefore, it is desired that the inorganic fibers used in the sealing material are highly safe for human body.

WO 05/110578 A1 1 has disclosed a sealing material containing, as inorganic fibers, at least one compound selected from the group consisting of an alkali metal compound, an alkaline earth metal compound and a boron compound.

The inorganic fibers containing the compound described in WO 05/110578 A1 are so-called biosoluble fibers. The biosoluble fibers are soluble in physiological saline solution. Therefore, if taken into human body, the biosoluble fibers are dissolved and discharged out of the body, and this is why they are considered to be highly safe for human body.

The contents of WO05/110578 A1 are incorporated herein by reference in their entirety.

### SUMMARY OF THE INVENTION

According to one aspect of the present invention, a sealing material for a honeycomb structure contains inorganic fibers including a biosoluble inorganic compound, inorganic particles, and an ion adsorbent in an amount of about 0.1% by weight or more.

According to another aspect of the present invention, a honeycomb structure includes a ceramic block and a peripheral sealing material layer. The ceramic block includes a honeycomb fired body in which a plurality of through holes are longitudinally formed with a partition wall interposed therebetween. The peripheral sealing material layer is formed on a peripheral surface of the ceramic block. The peripheral sealing material layer is formed by solidifying a sealing material for a honeycomb structure. The sealing material for a honeycomb structure includes inorganic fibers including a biosoluble inorganic compound, inorganic particles, and an ion adsorbent in an amount of about 0.1% by weight or more.

According to another aspect of the present invention, a method for manufacturing a honeycomb structure includes molding ceramic materials to construct a honeycomb molded body in which a plurality of through holes are longitudinally formed with a partition wall interposed therebetween. A ceramic block is constructed including a honeycomb fired body obtained after heat treatment of the honeycomb molded body. A peripheral sealing material paste layer formed on a peripheral surface of the ceramic block is solidified to form a peripheral sealing material layer. The method for manufacturing a honeycomb structure further includes preparing a sealing material for a honeycomb structure by mixing at least inorganic fibers containing a biosoluble inorganic compound, inorganic particles, and an ion adsorbent in an amount of about 0.1% by weight or more. The peripheral sealing material paste layer is formed of the sealing material for a honeycomb structure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view that schematically shows one example of a honeycomb structure according to an embodiment of the present invention;

FIG. 2A is a perspective view that schematically shows one example of a honeycomb fired body that constitutes the honeycomb structure according to an embodiment of the present invention, and FIG. 2B is an A-A line cross-sectional view of the honeycomb fired body shown in FIG. 2A;

FIG. 3A is a perspective view that shows a method for bonding the honeycomb fired bodies, and FIG. 3B is a perspective view that shows a sample for evaluation prepared by cutting the bonded honeycomb fired bodies;

FIG. 4 is a perspective view that schematically shows a method for measuring the breaking strength of the sealing material for a honeycomb structure (the adhesive layer) in the sample for evaluation; and

FIG. 5 is a graph that shows relations between the blending amount of each of the ion adsorbents with the breaking strength of the sealing materials for a honeycomb structure prepared in Examples and Comparative Examples.

### DESCRIPTION OF THE EMBODIMENTS

The conventional sealing material disclosed in WO05/110578 A1 is prepared by mixing an inorganic binder, an organic binder, inorganic particles, water, and the like in addition to the foregoing inorganic fibers as a paste-like mixture so as to be able to form a predetermined sealing material layer by applying the sealing material on a ceramic block or a honeycomb fired body.

However, when a sealing material is prepared using the biosoluble fibers as inorganic fibers and optionally adding an oxide sol and then stored, aggregation or gelation occurs in the paste-like sealing material along with the lapse of time. As a result, the viscosity of the sealing material increases, thereby reducing the flowability. When a phenomenon such as aggregation or gelation occurs in the sealing material, application of the sealing material to the ceramic block or the like becomes difficult, which has negative effects on the processability. Moreover, aggregation or gelation of the sealing material makes it difficult to uniformly apply the sealing material on the ceramic block and the like. As a result, variations tend to occur in the thickness of the applied sealing material, which causes variations in the final strength of the sealing material layer.

In a sealing material for a honeycomb structure according to an embodiment of the present invention, a honeycomb structure manufactured by using the sealing material for a honeycomb structure according to an embodiment of the present invention, and a method for manufacturing a honeycomb structure by using the sealing material for a honeycomb structure according to an embodiment of the present invention, biosolubility of inorganic fibers is good, and applicability to the ceramic block and the like even long after the preparation of the sealing material for a honeycomb structure is good.

The present inventors have studied the causes of the aggregation or gelation of the sealing material. As a result, they have found that, as the pH value of a sealing material paste increases, gelation of the sealing material becomes more likely to occur due to gelation of the inorganic particles and/or the oxide gel contained in the sealing material.

Although detailed mechanisms of the gelation of the sealing material have not been known, the mechanisms may be as follows.

That is, normally, electrical double layers are formed on the surfaces of the inorganic particles and the oxide sol contained in the sealing material. The electrical double layers are thought to allow the inorganic particles and the oxide sol to stably exist dispersed.

However, it is considered that when the pH value of the sealing material paste increases to, for example, more than about 6 (namely, under neutral conditions of around pH 7), polyvalent metal ions such as Ca²⁺ (calcium ion), and Mg²⁺ (magnesium ion) contained in the biosoluble fibers elute and interfere with the surface charge of the inorganic particles and/or the oxide sol. Due to the interference, the charge balance on the surface of the inorganic particles and/or the oxide sol is disturbed so that the organic particles and/or the oxide sol may aggregate, presumably causing gelation of the sealing material.

The pH value of the sealing material supposedly has an influence on frequency of diffusion contact between the polyvalent metal ions and inorganic particles and/or between the polyvalent metal ions and the oxide sol. A higher pH value increases frequency of the diffusion contact (increases the reaction rate), and thus gelation of the sealing material may be accelerated.

The term “gelation” used herein refers to a phenomenon of viscosity increase due to aggregation, association, or phase change of solid contents dispersed in a sol, which is caused by changes in the pH, presence of a polyvalent metal ion, and may cause increase of the viscosity of the sealing material paste.

Furthermore, adjusting the sealing material to be acidic (pH about 6 or lower) tends to prevent the polyvalent metal ions from eluting from the biosoluble fibers, and thus gelation of the sealing material may be prevented from occurring. In the case where the sealing material is acidic, it may become easier to prevent gelation of the sealing material. However, there is still a problem that, when the acidic sealing material is solidified, the strength of the solidified sealing material tends to be smaller than the strength of a sealing material which is free from the biosoluble fibers.

As a result of those investigations, the present inventors have found that it may become easier to provide a sealing material for a honeycomb structure, which has good applicability to the ceramic block and the like even long after the preparation of the sealing material paste and which has superior strength after being solidified by preventing the concentration of the polyvalent metal ions from decreasing or by preventing the polyvalent metal ions from existing in the sealing material before the polyvalent metal ions eluted from the biosoluble fibers diffuse and come into contact with the inorganic particles and/or the oxide sol, and thereby completing the present invention.

The mechanism of gelation of the sealing material may be mechanisms other than those mentioned earlier. Since the constitution of the present invention has been confirmed to constantly provide the aforementioned effects, the effects of the present invention are not varied depending upon the mechanism to be employed.

Namely, the sealing material for a honeycomb structure according to the embodiment of the present invention contains inorganic fibers including a biosoluble inorganic compound; inorganic particles; and an ion adsorbent in an amount of about 0.1% by weight or more.

The inorganic fibers contained in the sealing material for a honeycomb structure according to the embodiment of the present invention are biosoluble fibers. Therefore, even if the inorganic fibers are taken into a human body, as they are soluble under physiological conditions, safety for human body of the sealing material for a honeycomb structure containing the inorganic fibers tends to be secured. Further, gelation of the sealing material for a honeycomb structure tends not to occur and the sealing material has good applicability to the ceramic block and the like even long after the preparation of the sealing material paste.

Since the sealing material for a honeycomb structure according to the embodiment of the present invention contains the ion adsorbent, the sealing material tends to adsorb polyvalent metal ions such as Ca²⁺ and Mg²⁺ eluted from the biosoluble fibers. Therefore, the concentration of the polyvalent metal ions in the sealing material for a honeycomb structure tends to be decreased, and thus the polyvalent metal ions less frequently diffuse and come into contact with the inorganic particles and/or the oxide sol. As a result, aggregation, association or the like due to changes in the surface charge among the inorganic particles, among the inorganic particles and the oxide sol, or among the oxide sol tends to be suppressed, which tends to lead to prevention of gelation of the sealing material for a honeycomb structure.

Moreover, the sealing material for a honeycomb structure according to the embodiment of the present invention tends to increase the strength of the solidified sealing material for a honeycomb structure.

The ion adsorbent content in the sealing material for a honeycomb structure according to the embodiment of the present invention is preferably about 0.1% by weight or more, and more preferably about 0.2% by weight or more, though the content may vary depending on the kinds of the ion adsorbent. This is because, the ion adsorbent content of about 0.1% by weight or more in the sealing material for a honeycomb structure tends not to result in insufficient adsorption amount or adsorption rate of the polyvalent metal ions eluted from the inorganic fibers, and as a result, gelation of the sealing material for a honeycomb structure tends not to occur within about 24 hours of its preparation. Moreover, the ion adsorbent content of about 0.2% by weight or more in the sealing material for a honeycomb structure may favorably increase the strength of the solidified sealing material for a honeycomb structure.

In the sealing material for a honeycomb structure according to the embodiment of the present invention, the inorganic compound may be at least one of alkali metal compounds and alkaline earth metal compounds. Inclusion of the inorganic compound facilitates production of biosoluble inorganic fibers.

In the sealing material for a honeycomb structure according to the embodiment of the present invention, the ion adsorbent may be at least one of silica adsorbents, alumina adsorbents, zeolite adsorbents, clay adsorbents, mesoporous adsorbents, polyvalent metal salts, and activated carbon. Those adsorbents are desirable because they are chemically stable as inorganic adsorbents and are easily obtainable.

In the sealing material for a honeycomb structure according to the embodiment of the present invention, the ion adsorbent maybe a clay adsorbent. Since a clay adsorbent has high ion adsorption properties and is chemically stable, it may be suitably used as the ion adsorbent for the sealing material for a honeycomb structure according to the embodiment of the present invention.

In the sealing material for a honeycomb structure according to the embodiment of the present invention, the clay adsorbent may be at least one of bentonite, activated white clay, and montmorillonite. The clay adsorbents are easily obtainable and are excellent in ion adsorption properties. For those reasons, the clay adsorbents are suitable as the ion adsorbent to be used in the sealing material for a honeycomb structure according to the embodiment of the present invention. Since bentonite or the like itself has adhesion, it tends to function as inorganic binders as well. Therefore, use of the inorganic binder may be omitted in preparation of the sealing material for a honeycomb structure.

In the sealing material for a honeycomb structure according to the embodiment of the present invention, the ion adsorbent may be at least one of a zeolite adsorbent and activated carbon. Those ion adsorbents have high ion adsorption properties and are chemically stable, and thus they tend to prolong the durability period for use of the sealing material for a honeycomb structure.

In the sealing material for a honeycomb structure according to the embodiment of the present invention, the zeolite adsorbent may be specifically at least one of alminosilicate zeolite, metallosilicate zeolite, and aluminophosphate zeolite. The aforementioned zeolites, among zeolite adsorbents, have high ion adsorption properties, are easily obtainable, and are readily handled in processing.

In the sealing material for a honeycomb structure according to the embodiment of the present invention, the ion adsorbent may be a polyvalent metal salt.

Use of a polyvalent metal salt, even in a small amount, provides a better effect for preventing gelation, and thus the strength of the solidified sealing material for a honeycomb structure tends to be improved.

In the sealing material for a honeycomb structure according to the embodiment of the present invention, the polyvalent metal salt may be specifically at least one of aluminum phosphate, iron phosphate, magnesium phosphate, and aluminum fluoride. Since the aforementioned polyvalent metal salts have a low solubility, elution of polyvalent metal ions is less likely to occur. Also, the polyvalent metal salts have high ion adsorption properties, are easily obtainable, and are readily handled in processing.

The sealing material for a honeycomb structure according to the embodiment of the present invention may further contain an oxide sol. The sealing material for a honeycomb structure according to the embodiment of the present invention tends to be prevented from becoming a gel in a short time even under conditions where gelation of conventional sealing materials easily occurs, especially under alkaline conditions. Moreover, the strength of the solidified sealing material for a honeycomb structure tends to be improved due to the oxide sol contained therein.

The honeycomb structure according to the embodiment of the present invention includes a ceramic block including a honeycomb fired body in which a plurality of through holes are longitudinally formed with a partition wall interposed therebetween; and a peripheral sealing material layer formed on a peripheral surface of the ceramic block, wherein the peripheral sealing material layer is formed of the solidified sealing material for a honeycomb structure described above.

In the honeycomb structure according to the embodiment of the present invention, biosoluble fibers are used as one of the materials forming the peripheral sealing material layer. For this reason, the honeycomb structure is highly safe for human body and tends to be safely handled by users such as operators and consumers. Further, in the method for manufacturing the honeycomb structure according to the embodiment of the present invention, gelation of the sealing material for a honeycomb structure tends not to occur after preparation of the sealing material for a honeycomb structure until it is actually used. Therefore, it may become easier to prevent uneven thickness of the peripheral sealing material layer due to gelation in forming the peripheral sealing material layer. Accordingly, variation or reduction in the strength of the peripheral sealing material layer caused by uneven thickness tends to be prevented from occurring.

In the honeycomb structure according to the embodiment of the present invention, the ceramic block may include a plurality of the honeycomb fired bodies and an adhesive layer formed between side surfaces of the plurality of the honeycomb fired bodies.

In the honeycomb structure according to the embodiment of the present invention, the adhesive layer may be formed of a solidified adhesive.

In the honeycomb structure according to the embodiment of the present invention, the adhesive may be the aforementioned sealing material for a honeycomb structure. In the honeycomb structure formed of a plurality of the honeycomb fired bodies, adhesive layers are required between the honeycomb fired bodies, which inevitably increase the total amount of the inorganic fibers contained in the honeycomb structure. In the case of a conventional honeycomb structure, the chances of taking the inorganic fibers into human body are increased along with the increase of the adhesive layer. On the other hand, the aforementioned sealing material for a honeycomb structure is used as an adhesive in the honeycomb structure according to the embodiment of the present invention. Accordingly, even in the case where the total amount of the inorganic fibers is increased in the honeycomb structure as a whole, the safety of the honeycomb structure for human body tends to be secured.

The method for manufacturing a honeycomb structure according to the embodiment of the present invention includes: molding ceramic materials to construct a honeycomb molded body in which a plurality of through holes are longitudinally formed with a partition wall interposed therebetween; constructing a ceramic block including a honeycomb fired body obtained after heat treatment of the honeycomb molded body; and solidifying a peripheral sealing material paste layer formed on a peripheral surface of the ceramic block to form a peripheral sealing material layer, the method further including preparing a sealing material for a honeycomb structure by mixing at least inorganic fibers containing a biosoluble inorganic compound, inorganic particles, and an ion adsorbent in an amount of about 0.1% by weight or more, the peripheral sealing material paste layer being formed of the sealing material for a honeycomb structure.

In the method for manufacturing a honeycomb structure according to the embodiment of the present invention, as the sealing material for a honeycomb structure to be prepared contains about 0.1% by weight or more of the ion adsorbent, the inorganic particles tend not to aggregate or associate or the like with each other after preparation of the sealing material paste for a honeycomb structure, and thus gelation of the sealing material tends not to occur. As a result, it may become easier to prevent decrease in the flowability of the sealing material paste caused by increase in the viscosity even long after the preparation of the sealing material paste for a honeycomb structure. Moreover, as the flowability of the sealing material paste for a honeycomb structure tends to be kept at a high level, it may become easier to manage the use and the like of the sealing material paste. Further, processability in forming the peripheral sealing material paste layer on the peripheral surface of the ceramic block tends to be improved in forming the peripheral sealing material layer. Moreover, the strength of the solidified peripheral sealing material layer tends to be increased.

The method for manufacturing a honeycomb structure according to the embodiment of the present invention may further includes bonding a plurality of the honeycomb fired bodies with the adhesive layer interposed therebetween to construct the ceramic block. By including the bonding, it may become easier to manufacture an aggregated honeycomb structure formed of a plurality of the honeycomb fired bodies which are aggregated with each other.

In the method for manufacturing a honeycomb structure according to the embodiment of the present invention, the inorganic compound may be at least one of alkali metal compounds and alkaline earth metal compounds. Use of the aforementioned compound facilitates the inorganic fibers to function specifically as biosoluble fibers. As a result, it becomes easier to enhance the safety for human body of the sealing material for a honeycomb structure and the honeycomb structure using the sealing material for a honeycomb structure.

In the method for manufacturing a honeycomb structure according to the embodiment of the present invention, the ion adsorbent may be at least one of silica adsorbents, alumina adsorbents, zeolite adsorbents, clay adsorbents, mesoporous adsorbents, polyvalent metal salts, and activated carbon. The ion adsorbents have high ion adsorption properties and are chemically stable, and thus the durability period for use of the sealing material for a honeycomb structure tends to be prolonged. Therefore, it may become easier to prevent decrease in processability due to gelation of the sealing material, strength reduction due to uneven application of the sealing material or the like.

In the method for manufacturing a honeycomb structure according to the embodiment of the present invention, the ion adsorbent may be a clay adsorbent. Since a clay adsorbent has high ion adsorption properties and high chemical stability, it is favorably used as the ion adsorbent in the method for manufacturing a honeycomb structure according to the embodiment of the present invention.

In the method for manufacturing a honeycomb structure according to the embodiment of the present invention, the clay adsorbent may be at least one of bentonite, activated white clay, and montmorillonite. Those clay adsorbents are easily obtainable and excellent in ion adsorption properties, and therefore they are suitable as the ion adsorbent to be used in the method for manufacturing a honeycomb structure according to the embodiment of the present invention. Moreover, since bentonite or the like itself has adhesion, it tends to function as inorganic binders. Therefore, use of the inorganic binder may be omitted in preparation of the sealing material for a honeycomb structure.

In the method for manufacturing a honeycomb structure according to the embodiment of the present invention, the ion adsorbent may be at least one of a zeolite adsorbent and activated carbon.

The aforementioned zeolite adsorbent and activated carbon are very easily obtainable and tend to be readily handled. Therefore, preparation for the manufacturing tends to be facilitated and processability during the manufacturing tends to be improved. Moreover, since the zeolite adsorbent and activated carbon have high ion adsorption properties and are chemically stable, they tend to prolong the durability period for use of the sealing material for a honeycomb structure.

In the method for manufacturing a honeycomb structure according to the embodiment of the present invention, the zeolite adsorbent may be at least one of alminosilicate zeolite, metallosilicate zeolite, and aluminophosphate zeolite. Since the aforementioned adsorbents have high ion adsorption properties and are chemically stable, they tend to prolong the durability period for use of the sealing material for a honeycomb structure. Moreover, those adsorbents tend to be readily handled and thus favorably used in a manufacturing process in which safety and efficiency are required.

In the method for manufacturing a sealing material for a honeycomb structure according to the embodiment of the present invention, the ion adsorbent may be a polyvalent metal salt.

Use of a polyvalent metal salt, even in a small amount, provides a good effect for preventing gelation, tends to prolong the durability period for use of the sealing material for a honeycomb structure, and tends to increase the strength of the solidified sealing material for a honeycomb structure.

In the method for manufacturing a sealing material for a honeycomb structure according to the embodiment of the present invention, the polyvalent metal salt may be specifically at least one of aluminum phosphate, iron phosphate, magnesium phosphate, and aluminum fluoride. Since the aforementioned polyvalent metal salts have a low solubility, elution of polyvalent metal ions is less likely to occur. Also, the polyvalent metal salts have high ion adsorption properties, tend to prolong the durability period for use of the sealing material for a honeycomb structure, are easily obtainable, and are readily handled in processing.

In the method for manufacturing a honeycomb structure according to the embodiment of the present invention, the sealing material for a honeycomb structure may further include an oxide sol. In accordance with the method for manufacturing the sealing material for a honeycomb structure according to the embodiment of the present invention, even under conditions where gelation of conventional sealing materials easily occurs, especially under alkaline conditions, the sealing material for a honeycomb structure tends to be prepared while preventing the gelation. Moreover, the strength of the solidified sealing material for a honeycomb structure tends to be improved due to the oxide sol contained therein.

### First Embodiment

The following description will discuss the first embodiment of the sealing material for a honeycomb structure, the honeycomb structure, and the method for manufacturing the honeycomb structure according to the embodiment of the present invention with reference to drawings.

First, the sealing material for a honeycomb structure according to the first embodiment of the present invention will be discussed below.

The sealing material for a honeycomb structure of the present embodiment includes inorganic fibers containing a biosoluble inorganic compound; inorganic particles; and an ion adsorbent.

### (Inorganic Fibers Containing Biosoluble Inorganic Compound)

The inorganic fibers contained in the sealing material for a honeycomb structure is at least one of alkali metal compounds, and alkaline earth metal compounds.

Examples of the alkali metal compounds include oxides of Na, or K, and examples of the alkaline earth metal compounds include oxides of Mg, Ca, or Ba.

In order to evaluate the biosolubility of the inorganic fibers containing an inorganic compound, the solubility of the inorganic compound contained in the inorganic fibers in physiological saline can be measured by the following method. The inorganic fibers in an amount of about 0.5 g are added in about 25 ml of physiological saline. The resulting product is shaken for about five hours at a temperature of about 37° C. and then filtrated to remove solid content of the inorganic fibers. The extracted solution in which a portion of the inorganic fibers is dissolved is analyzed by atomic absorption spectrometry to measure the elements in the inorganic fibers such as silicon, sodium, calcium, and magnesium in the extracted solution. The physiological saline may be a commonly used one. When the total amount of the target compounds dissolved in the extracted solution is about 100 ppm (about 0.01% by weight) or more, the inorganic fibers are referred as inorganic fibers including biosoluble inorganic compounds. The ratio of the eluted material having been eluted from the inorganic fibers can be calculated based on the result of the measurement. In the case where the physiological saline originally contains the element to be measured, the amount of the element in the physiological saline is previously confirmed so that the amount is subtracted from the measured amount of the element in the sample.

It is desirable that the solubility of the inorganic fibers contained in the sealing material for a honeycomb structure of the present embodiment in physiological saline at about 37° C. is about 300 ppm (about 0.03% by weight) or more. The inorganic fibers having a solubility of about 300 ppm (about 0.03% by weight) or more tends to be immediately dissolved under physiological conditions, making it easier to further reduce risks caused upon taking of the inorganic fibers in a human body.

Moreover, the lower limit of the average fiber length of the aforementioned inorganic fibers is preferably about 0.1 μm, and the upper limit of the average fiber length of the aforementioned inorganic fibers is preferably about 1000 μm, more preferably about 100 μm, and still more preferably about 50 μm.

The average fiber length of about 0.1 μm or more may make it easier to form an elastic honeycomb structure. The average fiber length of about 1000 μm or less tends not to make the inorganic fibers form a pill-like shape. As a result, it may become easier to reduce the thickness of the adhesive layer or the peripheral sealing material layer. Moreover, when the average fiber length is about 1000 μm or less, the dispersibility of the inorganic particles is less likely to be deteriorated.

The inorganic fibers preferably have a large aspect ratio (major axis/minor axis). The inorganic fibers with a large aspect ratio are especially effective for improving the elasticity of the sealing materials.

The aspect ratio of the inorganic fibers included in the sealing material for a honeycomb structure of the present embodiment is preferably from about 2 to about 1000, more preferably from about 5 to about 800, and further more preferably from about 10 to about 500. When the aspect ratio of the inorganic fibers is about 2 or more, the inorganic fibers tend to contribute to improving the elasticity of the sealing material. When the aspect ratio of the inorganic fibers is about 1000 or less, the strength of the solidified sealing material such as the bonding strength to bond the honeycomb fired bodies is less likely to be reduced. In the case where there is a distribution in the aspect ratio, the aspect ratio is expressed as an average value.

The inorganic fibers preferably contain silica in an amount of from about 60% by weight to about 85% by weight, or more preferably from about 70% by weight to about 80% by weight. The silica refers to SiO or SiO₂. The silica content of about 60% by weight or more tends not to reduce the strength of the inorganic fibers. The silica content of about 85% by weight or less tends not to cause a reduction in the biosolubility due to the reduced amount of the inorganic compound in the inorganic fibers.

The inorganic fibers contain at least one of biosoluble alkali metal compounds or biosoluble alkaline earth metal compounds, and preferably further contain SiO₂ in an amount of about 70% by weight or more. Generally, many of alkali metal silicates and alkaline earth metal silicates are biosoluble. However, the SiO₂ content of about 85% by weight or less is preferable as the amount of the biosoluble alkali metal compound or the biosoluble alkaline earth metal compound tends not to become too small.

Moreover, the Al₂O₂ content in the inorganic fibers is preferably about 2% by weight or less. The Al₂O₂ content may be 0% by weight as long as the content is about 2% by weight or less, on the ground that generally an alkali metal aluminate or an alkali metal aluminosilicate and an alkaline earth metal aluminate or an alkaline earth metal aluminosilicate have no or little biosolubility.

The inorganic compound in the inorganic fibers contained in the sealing material for a honeycomb structure of the present embodiment is at least one of alkali metal compounds and alkaline earth metal compounds.

Examples of the alkali metal compounds include sodium oxides or salts, and potassium oxides or salts. Examples of the alkaline earth metal compounds include magnesium oxides or salts, calcium oxides or salts, and barium oxides or salts. Biosoluble fibers can be obtained by allowing the materials of inorganic fibers such as silica, alumina, silica alumina, or glass to contain sodium oxides or salts, potassium oxides or salts, magnesium oxides or salts, calcium oxides or salts, or barium oxides or salts.

The inorganic compound in the inorganic fibers may be a boron compound or may contain a boron compound.

### (Inorganic Particles)

The lower limit of the average particle diameter of the inorganic particles contained in the sealing material for a honeycomb structure is preferably about 0.01 μm, and more preferably about 0.1 μm. The upper limit of the average particle diameter of the inorganic particles is preferably about 100 μm, more preferably about 15 μm, and further more preferably about 10 μm. The average particle diameter of the inorganic particles of about 0.01 μm or more may make it easier to manufacture the inorganic particles and also tends not to increase the cost. On the other hand, the average particle diameter of the inorganic particles of about 100 μm or less tends not to induce a reduction in the strength of the solidified sealing material such as the bonding strength or the thermal conductivity of the solidified sealing material. The inorganic particles used herein refer to inorganic particles having an aspect ratio of less than about 2.

Examples of the inorganic particles include carbides, nitrides and the like, and specific examples thereof include inorganic powders or whiskers made of silicon carbide, silicon nitride, boron nitride and the like. Each of these maybe used alone, or two or more kinds of these may be used in combination. Silicon carbide particles, which are superior in thermal conductivity, are more preferably used among the inorganic particles.

In this description, whiskers are included in the inorganic particles.

### (Ion Adsorbent)

The ion adsorbent contained in the sealing material for a honeycomb structure is not particularly limited as long as the ion adsorbent is a substance with fine pores having absorption properties for absorbing absorbates (specifically metal cations). Examples of the adsorbents usable in the embodiment of the present invention include inorganic adsorbents, carbon adsorbents and the like.

The inorganic adsorbent is not particularly limited, and examples thereof include silica adsorbents, alumina adsorbents, zeolite adsorbents, clay adsorbents, mesoporous adsorbents, polyvalent metal salts, activated carbon, apatite adsorbents, layered zirconium phosphate, heteropoly acids, porous metal oxides, porous metal hydroxides and the like.

The silica adsorbent is not particularly limited, and examples thereof include silica gel, aero gel, colloidal silica, porous silicate glass and the like. The silica absorbent may be used alone, or two or more kinds of these may be used in combination.

Examples of the alumina adsorbent preferably include activated alumina such as α-alumina, γ-alumina, δ-alumina, θ-alumina and the like. Each of these may be used alone, or two or more kinds of these may be used in combination.

The zeolite adsorbent may be any of, or a combination of natural zeolites, synthetic zeolites, or artificial zeolites as long as it can adsorb cations. A preferable example among the above zeolites is at least one of aluminosilicate zeolite, metallosilicate zeolite, and aluminophosphate zeolite. This is because the above preferable zeolites have high ion adsorption properties, are easily obtainable, and are readily handled in processing among zeolite adsorbents.

Examples of the clay adsorbent include bentonite, smectite, smectite clay, activated white clay, montmorillonite and the like. Another examples of the clay adsorbent include kaolinite, acid clay, halloysite, sericite, mica clay minerals and the like. Each of these clay adsorbents may be used alone, or two or more kinds thereof may be used in combination.

Examples of the mesoporous adsorbent include mesoporous silica, mesoporous silica-alumina, mesoporous titania, mesoporous zirconia and the like, although not limited thereto. Each of these mesoporous adsorbents may be used alone, or two or more kinds thereof may be used in combination.

Examples of the polyvalent metal salts include aluminum phosphate, iron phosphate, magnesium phosphate, aluminum fluoride and the like, although not limited thereto. Each of these polyvalent metal salts may be used alone, or two or more kinds thereof may be used in combination. The polyvalent metal salts having a low solubility may be preferably used. This is because, since the polyvalent metal salts are for adsorbing dissolved alkali metals and the like, the amount of the metal ions dissolved from the polyvalent metal salts is preferably low. The polyvalent metal salts are preferably in shape of particles. This is because the polyvalent metal salts in fiber-like shape may cause a negative influence on human body.

Examples of the apatite adsorbent include hydroxy apatite or the like.

Examples of the heteropoly acid include tungstophosphate salt or the like. Examples of the porous metal oxide include α-type tin oxide, β-type tin oxide and the like. Examples of the porous metal hydroxide include aluminium oxyhydroxide, iron oxyhydroxide, chrome oxyhydroxide, cobalt oxyhydroxide, nickel oxyhydroxide and the like, although not limited thereto. Each of these heteropoly acids or porous metal oxides may be used alone, or two or more kinds thereof may be used in combination.

Preferable among the aforementioned inorganic ion adsorbents is at least one of clay adsorbents, silica adsorbents, alumina adsorbents, zeolite adsorbents, polygonal metal salts, and mesoporous adsorbents. Those adsorbents are chemically stable as an inorganic adsorbents and are easily obtainable. Moreover, the inorganic ion adsorbents are more preferably clay adsorbents or zeolite adsorbents. This is because those adsorbents are excellent in cation adsorption properties and tend to prevent gelation of the sealing material for a honeycomb structure for a long period of time.

The carbon adsorbent is not particularly limited, and activated carbon or the like can be preferably used. This is because activated carbon is excellent in cation adsorption properties and advantageously hardly causes interaction with other components.

The sealing material for a honeycomb structure according to the present embodiment basically includes the aforementioned inorganic fibers, the inorganic particles, and the ion adsorbent. However, for preparing a flowable sealing material for a honeycomb structure, an optimum amount of solvent such as water needs to be added. Furthermore, it is preferable to add an oxide sol, an organic binder, a water retention agent, or other additives, if necessary.

The lower limit of the amount of the inorganic fibers contained in the sealing material for a honeycomb structure of the present embodiment is preferably about 10% by weight and more preferably about 20% by weight. The upper limit of the amount of the inorganic fibers is preferably about 70% by weight, more preferably about 40% by weight, and further more preferably about 30% by weight. The inorganic fiber content of about 10% by weight or more tends not to cause a reduction in the elasticity of the solidified sealing material for a honeycomb structure. On the other hand, the inorganic fiber content of about 70% by weight or less tends not to cause a reduction in the thermal conductivity of the solidified sealing material for a honeycomb structure and also tends not to reduce the strength such as the bonding strength of the solidified sealing material for a honeycomb structure.

The lower limit of the amount of the inorganic particles contained in the sealing material for a honeycomb structure of the present embodiment is preferably about 3% by weight, more preferably about 10% by weight, and further more preferably about 20% by weight. The upper limit of the amount of the inorganic particles is preferably about 80% by weight, more preferably about 60% by weight, and further more preferably about 40% by weight. The inorganic particle content of about 3% by weight or more tends not to cause a reduction in the thermal conductivity of the solidified sealing material for a honeycomb structure. The inorganic particle content of about 80% by weight or less tends not to cause a reduction in the bonding strength when the solidified sealing material for a honeycomb structure (adhesive layer or peripheral sealing material layer) is exposed to high temperatures.

The amount of the ion adsorbent in the sealing material for a honeycomb structure according to the present embodiment is not particularly limited as long as the gelation preventive effect of the sealing material for a honeycomb structure is obtained. The ion adsorbent content is preferably about 0.1% by weight or more, more preferably about 0.2% by weight or more, and further more preferably about 0.4% by weight or more. The ion adsorbent content of about 0.1% by weight or more in the sealing material for a honeycomb structure tends not to lead to insufficient absorption amount or absorption rate of the polyvalent metal ions eluted from the inorganic fibers. As a result, gelation of the sealing material for a honeycomb structure tends not to occur within about 24 hours of preparation.

The upper limit of the ion adsorbent content is not particularly limited. The ion adsorbent content is preferably about 5.0% by weight or less, and more preferably about 2.0% by weight or less. As the amount of the ion adsorbent is increased, the amount of the components other than the ion adsorbent, especially the inorganic fibers in the sealing material for a honeycomb structure is decreased. As a result, the strength or the elasticity of the solidified sealing material for a honeycomb structure is more likely to be reduced. Taking the above into consideration, the ion adsorbent content in the sealing material for a honeycomb structure may be determined to the extent that the reduction in the strength or the elasticity of the solidified sealing material for a honeycomb structure does not substantially have an effect on the practical use.

When bentonite is used as the ion adsorbent, the content thereof is preferably from about 0.1% by weight to about 5.0% by weight, more preferably from about 0.2% by weight to about 5.0% by weight, and further more preferably from about 0.2% by weight to about 2.0% by weight . When zeolite is used as the ion adsorbent, the content thereof is preferably from about 0.1% by weight to about 5.0% by weight, more preferably from about 0.2% by weight to about 5.0% by weight, and further more preferably from about 0.2% by weight to about 2.0% by weight . The amount of bentonite or zeolite of about 0.2% by weight or more as the ion adsorbent leads to excellent strength of the solidified sealing material for a honeycomb structure. When aluminum phosphate is used as the ion adsorbent, the content thereof is preferably from about 0.1% by weight to about 2.0% by weight, more preferably from about 0.1% by weight to about 0.5% by weight, and further more preferably from about 0.2% by weight to about 0.5% by weight. Moreover, the content of aluminum phosphate is further more preferably from about 0.10% by weight to about 0.25% by weight, and particularly preferably from about 0.20% by weight to about 0.25% by weight. The amount of aluminum phosphate of about 0.1% by weight or more as the ion adsorbent tends to prevent gelation of the sealing material for a honeycomb structure, leading to excellent strength of the solidified sealing material for a honeycomb structure. When aluminum phosphate is used as the ion adsorbent, the strength tends to significantly increase as the amount of the aluminum phosphate is increased. Bentonite, zeolite, and aluminum phosphate are easily available among the ion adsorbents. Further, a honeycomb structure in which any of bentonite, zeolite, or aluminum phosphate is used tends not to cause a reliability problem.

The weight ratio of the ion adsorbent to the inorganic fibers (weight of inorganic fibers/weight of ion adsorbent) in the sealing material for a honeycomb structure according to the present embodiment is not particularly limited, and may be from about 100/1 to about 4/1, and preferably from about 80/1 to about 8/1. When the weight ratio of the ion adsorbent to the inorganic fibers is within the range of from about 100/1 to about 4/1, the amount of the ion adsorbent present in the sealing material for a honeycomb structure tends not to become low, and tends not to lead to insufficient absorption of the polyvalent ions, or the amount of the inorganic fibers present in the sealing material for a honeycomb structure tends not to become low, and tends not to lead to insufficient strength or elasticity of the solidified sealing material for a honeycomb structure.

### (Oxide Sol)

As mentioned earlier, an oxide sol may be added in the sealing material for a honeycomb structure according to the present embodiment.

Examples of the oxide sol include silica sol, alumina sol, zirconia sol and the like. Each of these may be used alone, or two or more kinds of these may be used in combination. The oxide sol functions as a binder to bond the particles with each other after solidifying the sealing material. Taking those functions and processability into consideration, the oxide sol may be preferably silica sol or alumina sol. The oxide sol may be acidic or alkaline.

The lower limit of the amount of the oxide sol contained in the sealing material for a honeycomb structure is preferably about 1% by weight, and more preferably about 5% by weight as a solid content. The upper limit thereof is preferably about 30% by weight, more preferably about 15% by weight, and further more preferably about 9% by weight as a solid content. The amount of the oxide sol of about 1% by weight or more as a solid content tends not to cause a reduction in the strength such as the bonding strength of the solidified sealing material for a honeycomb structure. The amount of the oxide sol of about 30% by weight or less as a solid content tends not to cause a reduction in the thermal conductivity of the solidified sealing material for a honeycomb structure.

The average particle diameter of the oxide included in the oxide sol is preferably from about 5 nm to about 30 nm.

The smaller the average particle diameter of the oxide contained in the oxide sol is, the more the strength such as the bonding strength to bond the honeycomb fired bodies tends to improve. However, when the average particle diameter of the oxide is about 5 nm or more, the dispersibility of the oxide in the sealing material tends not to be deteriorated. Further, the oxide having the average particle diameter of about 5 nm or more tends not to be difficult to manufacture and thus the oxide sol tend not to be hardly available. When the average particle diameter of the oxide is about 30 nm or less, the bonding strength between the sealing material for a honeycomb structure and the honeycomb fired bodies tend not to be decreased.

In this description, the average particle diameter of the oxide contained in the oxide sol is the value measured, for example, by using the following method.

Specifically, when the oxide sol is a silica sol, first, the silica sol is dried, and its BET specific surface area is measured.

Thereafter, supposing that silica particles in the silica sol are spherical particles of a dense body, the particle diameter is calculated from the following formula (1):

BET specific surface area=(6000/ρ)/particle diameter (1)

(in the formula, “ρ” is the true density of silica (2.2 g/cm³)) (pH value of sealing material for a honeycomb structure)

When the sealing material for a honeycomb structure according to the present embodiment contains the oxide sol, the sealing material for a honeycomb structure may be alkaline. Even under alkaline conditions where conventionally gelation tends to occur in sealing materials for a honeycomb structure, gelation tends to be prevented from occurring or start of gelation tends to be delayed in the sealing material for a honeycomb structure according to the present embodiment due to the ion adsorbent contained therein. Moreover, due to the oxide sol contained as well in the sealing material for a honeycomb structure, the strength of the solidified sealing material for a honeycomb structure tends to be improved.

When an alkaline sealing material for a honeycomb structure is used, the sealing material may have a pH value of from about 7 to about 11, and preferably from about 8 to about 10.

The sealing material for a honeycomb structure may be acidic as long as its practical use is not substantially affected in consideration of prevention of gelation or strength after solidification of the sealing material for a honeycomb structure. The acidic sealing material for a honeycomb structure may have a pH value of from about 3 to about 7, and preferably from about 4 to about 6.

The sealing material for a honeycomb structure according to the present embodiment mainly includes the inorganic fibers, the inorganic particles and the ion adsorbent mentioned earlier, and further optionally includes the oxide sol. In order to allow the sealing material for a honeycomb structure to have flowability, an optimum amount of solvent such as water needs to be added. Furthermore, it is preferable to add an organic binder, a water retention agent, or other additives, if necessary.

Since the organic binder provides the honeycomb fired bodies or the like with adhesive properties and also bonds the materials with each other upon forming a sealing material layer for a honeycomb structure, the organic binder is preferably included in the sealing material for a honeycomb structure.

Examples of the organic binder include polyvinyl alcohol, methylcellulose, ethylcellulose, carboxylmethylcellulose and the like. Each of these may be used alone, or two or more kinds thereof may be used in combination. Carboxymethylcellulose is preferably used among the aforementioned organic binders.

The organic binder content in the sealing material for a honeycomb structure according to the present embodiment is preferably from about 0.1% by weight to about 1.0% by weight. The organic binder content of about 0.1% by weight or more tends to properly bond the materials with each other, and tends not to lead to reduction in the strength of the solidified sealing material for a honeycomb structure. The organic binder content of about 1.0% by weight or less tends not to excessively increase the viscosity of the sealing material for a honeycomb structure, and tends not to make it difficult to apply the sealing material. Furthermore, after the honeycomb structure body is mounted in an exhaust gas purifying apparatus, the sealing material layer tends not to be decomposed and tends not to produce a large volume of hydrocarbon gases upon contacting with exhaust gases.

The water retention agent used herein refers to a substance which absorbs moisture upon contacting thereto so as to prevent the moisture from shifting to other parts. Therefore, addition of the water retention agent tends to prevent the reduction in the flowability of the sealing material paste for a honeycomb structure.

The water retention agent content in the sealing material for a honeycomb structure according to the present embodiment is preferably from about 0.1% by weight to about 1.0% by weight. The water retention agent content of about 0.1% by weight or more tends not to lead to excessively high viscosity of the sealing material paste for a honeycomb structure due to absorption of water by the inorganic fibers, inorganic particles and other components, and tends not to make the application of the sealing material for a honeycomb structure difficult. The water retention agent content of about 1.0% by weight or less tends not to excessively increase the amount of the water retention agent. As a result, the viscosity of the sealing material paste for a honeycomb structure tends not to become too high, and thus the flowability thereof tends not to be hardly maintained.

Examples of the water retention agent include polyvinyl alcohol, polyacrylamides, cellulose derivatives, polysaccharides and the like.

As the solvent, water may be exemplified. Further, alcohol and the like may be added.

The amount of the solvent to be added is not particularly limited. In the case of water, the water content in the sealing material for a honeycomb structure is preferably from about 20% by weight to about 50% by weight. The water content of about 20% by weight or more tends to maintain the flowability of the sealing material for a honeycomb structure. The water content of about 50% by weight or less tends not to excessively reduce the viscosity of the sealing material paste for a honeycomb structure, and tends not to make the application difficult.

The following description will discuss the method for preparing the sealing material for a honeycomb structure according to the present embodiment.

The sealing material for a honeycomb structure can be prepared by first mixing the inorganic fibers, the inorganic particles, the ion adsorbent, and optionally the oxide sol at the aforementioned proportion to prepare a mixture, followed by addition of the optimal amount of water, the organic binder, and the water retention agent and the like, if necessary, and then mixing the resulting mixture. The pH value of the prepared sealing material for a honeycomb structure is not particularly limited, and is preferably from about 4 to about 7.

The pH value may be adjusted by adding an acidic solution or by adding an alkaline hydroxide and the like. Kinds of the acidic solution are not particular limited, and examples thereof include a water solution of hydrochloric acid, sulfric acid, nitric acid, phosphoric acid, lactic acid, acetic acid, formic acid and the like. A water solution of lactic acid is especially preferable among the above acidic solutions.

The prepared sealing material for a honeycomb structure contains well-biosoluble inorganic fibers, has good applicability to the ceramic block and the like even long after the preparation of the sealing material paste for a honeycomb structure, and tends to prevent strength reduction of the solidified sealing material for a honeycomb structure. Moreover, since an ion adsorbent is contained, it may become easier to provide the sealing material (adhesive layer or peripheral coating material layer) for a honeycomb structure having a larger strength after being solidified.

The following description will discuss a honeycomb structure according to the first embodiment of the present invention.

The honeycomb structure of the present embodiment is manufactured by using the aforementioned sealing material for a honeycomb structure of the present embodiment.

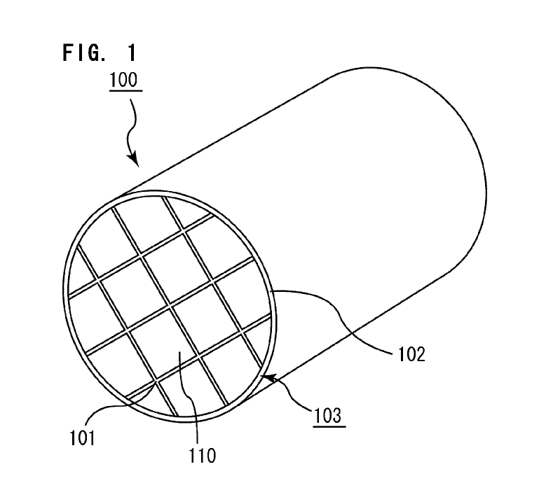

FIG. 1 is a perspective view that schematically shows one example of a honeycomb structure according to an embodiment of the present invention.

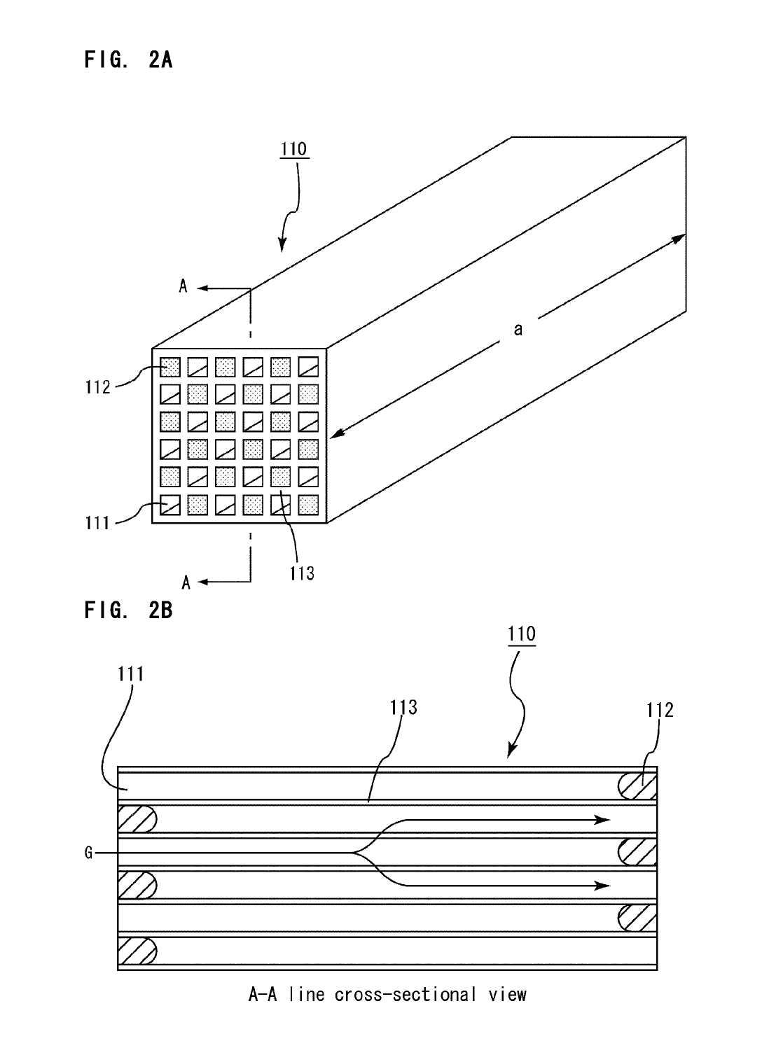

FIG. 2A is a perspective view that schematically shows one example of a honeycomb fired body that constitutes the honeycomb structure according to an embodiment of the present invention, and FIG. 2B is an A-A line cross-sectional view of the honeycomb fired body shown in FIG. 2A.

A honeycomb structure 100 shown in FIG. 1 has a structure in which a plurality of porous silicon carbide honeycomb fired bodies 110 are bonded with one another with an adhesive layer 101 interposed therebetween to construct a ceramic block 103, with a peripheral sealing material layer 102 formed on the periphery face of the ceramic block 103.

The honeycomb fired body 110 has a shape shown in FIGS. 2A and 2B.

The honeycomb fired body 110 shown in FIGS. 2A and 2B has a structure in which a large number of cells (through holes) 111 are longitudinally (the direction “a” in FIG. 2A) placed in parallel with one another with a cell wall (partition wall) 113 therebetween, and either one end of each of the cells 111 is plugged with a plug 112. Therefore, exhaust gases “G” having flowed into one of the cells 111 with an opening end on one end face surely passes through the cell wall 113 that separates the cells 111, and flows out from another cell 111 with an opening end on the another end face.

Therefore, the cell wall 113 functions as a filter for capturing PM and the like.

In the honeycomb structure of the present embodiment, the adhesive layer and the peripheral sealing material layer are formed by using the sealing material for a honeycomb structure of the present embodiment.

The following description will discuss embodiments of the method for manufacturing a honeycomb structure using the sealing material for a honeycomb structure according to the first embodiment.

First, molding for manufacturing a honeycomb molded body is performed by extrusion-molding a wet mixture containing ceramic powders and a binder.

Specifically, as the ceramic powders, silicon carbide powders having different average particle diameters, an organic binder, a plasticizer in liquid form, a lubricant and water are mixed to prepare a wet mixture for manufacturing a honeycomb molded body.

Successively, this wet mixture is loaded into an extrusion molding machine and extrusion-molded so that a honeycomb molded body having a predetermined shape is manufactured.

Next, the honeycomb molded body is cut into a predetermined length, and dried by using a drying apparatus, such as a microwave drying apparatus, a hot-air drying apparatus, a dielectric drying apparatus, a reduced-pressure drying apparatus, a vacuum drying apparatus, and a freeze drying apparatus. Thereafter, plugging is carried out by filling predetermined cells with a plug material paste to be a plug for plugging the cells.

Next, degreasing is carried out to remove the organic components in the honeycomb molded body by heating the honeycomb molded body in a degreasing furnace. The degreased honeycomb molded body is transferred to a firing furnace to carry out firing so that a honeycomb fired body is manufactured.

Here, conditions conventionally used upon manufacturing a honeycomb fired body are applicable for carrying out the cutting, drying, plugging, degreasing and firing.

Next, bonding is carried out by forming the adhesive layer between a plurality of the honeycomb fired bodies so that the plurality of the honeycomb fired bodies are bonded with one another with the adhesive layer interposed therebetween according to the following method.

A paste-like adhesive which is the sealing material for a honeycomb structure of the present embodiment is applied on a predetermined side surface of each of the honeycomb fired bodies in which a predetermined end of each of the cells is plugged so as to form an adhesive paste layer. On the adhesive paste layer is placed one of the other honeycomb fired bodies, and this process is sequentially repeated so that a honeycomb aggregated body in which the plurality of the honeycomb fired bodies are bonded with one another with the adhesive paste layer interposed therebetween is manufactured.

Next, the adhesive paste layer is solidified by heating the honeycomb aggregated body so that a ceramic block having an adhesive layer is constructed.

Thereafter, periphery cutting is performed by cutting side surfaces of the ceramic block using a diamond cutter or the like so that the ceramic block has a round pillar shape.

Further, forming a peripheral sealing material layer on the peripheral surface of the ceramic block is carried out according to the following method.

A peripheral sealing material paste layer is formed by applying the sealing material for a honeycomb structure of the present embodiment using a squeeze. By solidifying the peripheral sealing material paste layer, a peripheral sealing material layer is formed.

The sealing material for a honeycomb structure according to the embodiment of the present invention may be used as a material for forming the peripheral sealing material layer.

According to the processes mentioned earlier, a honeycomb structure including the sealing material for a honeycomb structure (adhesive layer and peripheral sealing material layer) of the present embodiment can be manufactured.

As in this case, the honeycomb structure of the present embodiment may be an aggregated honeycomb structure in which the ceramic block includes a plurality of the honeycomb fired bodies. The honeycomb structure of the present embodiment may be an integrated honeycomb structure in which the ceramic block is formed of a single honeycomb fired body as well.

The effects of the sealing material for a honeycomb structure, the honeycomb structure, and the method for manufacturing a honeycomb structure according to the present embodiment will be recited below.

(1) The inorganic fibers contained in the sealing material for a honeycomb structure of the present embodiment are biosoluble fibers. Therefore, even if the inorganic fibers are taken into human body, as they are soluble under physiological conditions, it may become easier to secure the safety for human body of the sealing material for a honeycomb structure containing the inorganic fibers.

Moreover, the honeycomb structure manufactured by using the sealing material for a honeycomb structure of the present embodiment is highly safe for human body and tends to be safely handled by users such as operators and consumers.

Further, operators tend to safely work in the manufacture of a honeycomb structure by using the sealing material for a honeycomb structure of the present embodiment.

(2) Since the sealing material for a honeycomb structure of the present embodiment contains the ion adsorbent, it tends to adsorb polyvalent metal ions such as Ca²⁺ and Mg²⁺ eluted from the biosoluble fibers. Therefore, the polyvalent metal ion concentration in the sealing material for a honeycomb structure tends to be reduced and thus the polyvalent metal ions less frequently diffuse and come into contact with the inorganic particles and/or the oxide sol. As a result, aggregation, association or the like due to changes in the surface charge among the inorganic particles, among the inorganic particles and the oxide sol, or among the oxide sol tends to be suppressed, which tends to prevent gelation of the sealing material for a honeycomb structure. Accordingly, the sealing material for a honeycomb structure tends not to form a gel even long after the preparation of the sealing material paste, and has a good applicability to the ceramic block or the like.

When forming the peripheral sealing material layer of the honeycomb structure by using the sealing material for a honeycomb structure of the present embodiment, gelation of the sealing material for a honeycomb structure tends not to occur, and thus it may become easier to prevent uneven thickness of the peripheral sealing material layer due to difficulty in evenly applying the sealing material paste for a honeycomb structure. Accordingly, it may become easier to prevent variation or reduction in the strength of the peripheral sealing material layer caused by uneven thickness of the peripheral sealing material layer.

(3) The sealing material for a honeycomb structure according to the present embodiment may contain an ion adsorbent such as a zeolite adsorbent, a clay adsorbent, polyvalent metal ions and the like in addition to the inorganic fibers and the inorganic particles. The ion adsorbents mentioned earlier have excellent mechanical properties needed to maintain the strength of the solidified sealing material for a honeycomb structure. Therefore, reduction in the strength of the solidified sealing material for a honeycomb structure tends to be prevented, and thus it may become easier to form the sealing material (adhesive layer or peripheral coating material layer) having improved mechanical properties.

(4) The honeycomb structure according to the present embodiment is an aggregated honeycomb structure including a plurality of the honeycomb fired bodies.

In the honeycomb structure in which a plurality of the honeycomb fired bodies are aggregated, an adhesive layer is necessary between the honeycomb fired bodies. Therefore, the total amount of the inorganic fibers contained in the honeycomb structure is inevitably increased. Even in this case, since the sealing material for a honeycomb structure of the present embodiment is used as an adhesive in the honeycomb structure of the present embodiment, it may become easier to secure the safety of the honeycomb structure for human body.

(5) In the honeycomb structure of the present embodiment, the peripheral sealing material layer is formed by solidifying the sealing material for a honeycomb structure of the present embodiment. Since the sealing material for a honeycomb structure of the present embodiment tends to show no decrease in the strength of the solidified sealing material for a honeycomb structure, damages such as cracks tend to be prevented from occurring in the peripheral sealing material layer.

(6) In the honeycomb structure of the present embodiment, the adhesive layer is formed by solidifying the sealing material for a honeycomb structure of the present embodiment. Since the sealing material for a honeycomb structure of the present embodiment tends to show no decrease in the strength of the solidified sealing material for a honeycomb structure, it may become easier to prevent sliding or coming off of the honeycomb fired bodies which are bonded with one another with the adhesive layer interposed therebetween in the case where the honeycomb structure including the honeycomb fired bodies is used as a exhaust gas purifying apparatus. Therefore, the honeycomb structure tends to be stably used for a long period of time.

(7) In the method for manufacturing a honeycomb structure of the present embodiment, when forming a peripheral sealing material layer, the sealing material for a honeycomb structure of the present embodiment is applied on a peripheral surface of the ceramic block. Further, when forming the adhesive layer, the sealing material for a honeycomb structure of the present embodiment is applied on a side surface of the honeycomb fired body. Since the sealing material for a honeycomb structure of the present embodiment tends to show no decrease in the flowability of the sealing material paste caused by increase in the viscosity of the sealing material paste even long after the preparation of the sealing material paste, it may become easier to prevent a reduction in the processability upon formation of the peripheral sealing material layer or the adhesive layer.

### Examples

Examples which specifically disclose the first embodiment of the present invention will be described below. The present invention is not limited to those Examples.

### (1) Preparation of Sealing Material for a Honeycomb Structure

In each of the Examples and Comparative Examples, a sealing material for a honeycomb structure was prepared using inorganic fibers “A” having the composition shown in Table 1 below.

TABLE 1

| | Inorganic | Inorganic |
|---|---|---|
| | fibers A | fibers B |
| SiO₂ (wt %) | 70.8 | 74.8 |
| MgO (wt %) | 0.6 | 17.9 |
| CaO (wt %) | 25.9 | 4.4 |
| Al₂O₃ (wt %) | 0.8 | 1.3 |
| Others | 1.9 | 1.6 |

### Example 1

### (Preparation of Sealing Material for a Honeycomb Structure)

A sealing material for a honeycomb structure having a pH value of 6.3 was prepared by mixing 438.9 parts by weight of the biosoluble fiber containing inorganic fibers “A” as inorganic fibers, 367.5 parts by weight of SiC powders having an average particle diameter of 0.5 μm as inorganic particles, 4.6 parts by weight of carboxymethyl cellulose (CMC) as an organic binder, 283.6 parts by weight of a bentonite dispersion liquid (Trade name: W-200U, manufactured by Topy Industries Ltd.) containing 2% by weight of bentonite as an ion adsorbent, 22.7 parts by weight of polyvinyl alcohol (PVA) as a water retention agent, and 50.0 parts by weight of water, followed by kneading. The concentration of the bentonite in the sealing material for a honeycomb structure was 0.5% by weight.

### Examples 2 to 5

A sealing material for a honeycomb structure was prepared in the same manner as that in Example 1, except that the bentonite content in the sealing material for a honeycomb structure was changed to the blending amount shown in Table 2 below. Table 2 shows the pH value of the thus obtained sealing material for a honeycomb structure of Examples 2 to 5.

### Examples 6 and 7

In Example 6, a sealing material for a honeycomb structure was prepared in the same manner as that in Example 1, except that an acidic silica sol (pH: 6.3, silica content: 30% by weight) was added to the sealing material for a honeycomb structure at the blending amount shown in Table 2 below, and further 0.7 parts by weight of a lactic acid solution (lactate concentration: 50% by weight) as a pH adjusting agent was added. In Example 7, a sealing material for a honeycomb structure was prepared in the same manner as that in Example 1, except that an alkaline silica sol (pH: 8.8, silica content: 30% by weight) was added at the blending amount shown in Table 2 below. The pH value of the resulting sealing material for a honeycomb structure of Examples 6 and 7 is shown in Table 2.

### Examples 8 to 10

A sealing material for a honeycomb structure was prepared in the same manner as that in Example 1, except that, in place of bentonite, a solution containing montmorillonite or kaolinite in the blending amount shown in Table 2 was used. The pH value of the resulting sealing material for a honeycomb structure of Examples 8 to 10 is shown in Table 2.

### Comparative Examples 1 and 2

In Comparative Example 1, a sealing material for a honeycomb structure was prepared in the same manner as that in Example 1, except that the ion adsorbent was not added and an acidic silica sol (pH: 6.3, silica content: 30% by weight) was added in the blending amount shown in Table 2 below and further 6.8 parts by weight of a lactic acid solution (lactate concentration: 50% by weight) as a pH adjusting agent was added. In Comparative Example 2, a sealing material for a honeycomb structure was prepared in the same manner as that in Example 1, except that the ion adsorbent was not added, and alkaline silica sol (pH: 9.9, silica content: 30% by weight) was added at the blending amount shown in Table 2. Table 2 shows the pH values of the thus obtained sealing materials for a honeycomb structure of Comparative Examples 1 and 2.

### Examples 11 to 15

A sealing material for a honeycomb structure was prepared in the same manner as that in Example 1, except that, in place of bentonite, a solution containing zeolite (A-type zeolite) in the blending amount shown in Table 3 was used. Table 3 shows the pH value of the resulting sealing material for a honeycomb structure of Examples 11 to 15.

### Examples 16 to 18

A sealing material for a honeycomb structure was prepared in the same manner as that in Example 1, except that, in place of bentonite, a solution containing aluminum phosphate in the blending amount shown in Table 3 was used, and an alkaline silica sol (pH: 8.8, silica content: 30% by weight) was added at the blending amount shown in Table 3. Table 3 shows the pH value of the resulting sealing material for a honeycomb structure of Examples 16 to 18.

### Example 19

A sealing material for a honeycomb structure was prepared in the same manner as that in Example 1, except that, in place of bentonite, a solution containing aluminum phosphate in the blending amount shown in Table 3 was used, and an acidic silica sol (pH: 6.3, silica content: 30% by weight) was added at the blending amount shown in Table 3. Table 3 shows the pH value of the resulting sealing material for a honeycomb structure of Example 19.

### Example 20 and Comparative Example 3

A sealing material for a honeycomb structure was prepared in the same manner as that in Example 1, except that, in place of bentonite, a solution containing aluminum phosphate in the blending amount shown in Table 3 was used. The pH value of the resulting sealing material for a honeycomb structure of Example 20 and Comparative Example 3 is shown in Table 3.

The sealing materials for a honeycomb structure prepared in Examples and Comparative Examples were evaluated by the methods mentioned below.

### (2) Evaluation of Sealing Material for a Honeycomb Structure

### (2-1) Flowability Evaluation Based on Viscosity of Sealing Material for a Honeycomb Structure

For each of the sealing materials for a honeycomb structure prepared in Examples and Comparative Examples, flowability was measured with a B-type viscometer immediately after, one day after, two days after, three days after, and seven days after the preparation of the sealing materials (paste) for a honeycomb structure. The rotation of the viscometer was 10 rpm, and the temperature was 25° C. at the time of the measurement. Tables 2 and 3 show the results of the flowability evaluation based on viscosity of sealing material for a honeycomb structure. In the case where the viscosity was already too high at the time of measurement to be measured, no data of the results are shown in the tables. The data “300 Pa·s” in the measurement results of the viscosity indicates that a measurement result of more than 300 Pa·s was obtained and thus the result was formally described as 300 Pa·s.

### (2-2) Manufacture of Sample for Evaluation, and Evaluation of Mechanical Properties of Solidified Sealing Material for a Honeycomb Structure Based on Breaking Strength Using the Sample for Evaluation

In order to evaluate the sealing material for a honeycomb structure, honeycomb fired bodies were manufactured and a sample for evaluation was manufactured using the honeycomb fired bodies. Breaking strength of the sample for evaluation was evaluated.

Namely, two pieces of the honeycomb fired bodies were bonded using the sealing material for a honeycomb structure, and cutting was performed on the bonded honeycomb fired bodies to manufacture a sample for evaluation. The sample was used for evaluations. Accordingly, first, manufacturing process of the sample for evaluation will be discussed, and thereafter evaluation methods will be explained below.

### (Manufacturing of Honeycomb Fired Body)

An amount of 52.8% by weight of silicon carbide coarse powders having an average particle diameter of 22 μm and an amount of 22.6% by weight of a silicon carbide fine powder having an average particle diameter of 0.5 μm were mixed. To the resulting mixture, 2.1% by weight of an acrylic resin, 4.6% by weight of an organic binder (methylcellulose), 2.8% by weight of a lubricant (UNILUB, manufactured by NOF Corporation), 1.3% by weight of glycerin, and 13.8% by weight of water were added, and then kneaded to prepare a wet mixture. The obtained wet mixture was extrusion-molded, so that a raw honeycomb molded body having virtually the same shape as the shape shown in FIG. 2A and having cells not plugged was manufactured.

Next, the raw honeycomb molded body was dried by using a microwave drying apparatus to obtain a dried honeycomb molded body. Then, using a plug material paste having the same composition as that of the wet mixture, predetermined cells were filled, and the dried honeycomb molded body in which the plug material paste was filled was again dried by using a drying apparatus.

The dried honeycomb molded body was degreased at 400° C., and then fired at 2200° C. under normal pressure argon atmosphere for three hours, so that a honeycomb fired body including a silicon carbide sintered body, with a porosity of 45%, an average pore diameter of 15 a size of 34.3 mm×34.3 mm×150 mm, the number of cells (cell density) of 300 pcs/inch² and a thickness of the cell wall of 0.25 mm (10 mil), was manufactured.

### (Manufacturing of Samples for Evaluation)

Next, samples for evaluation were manufactured according to the following method.

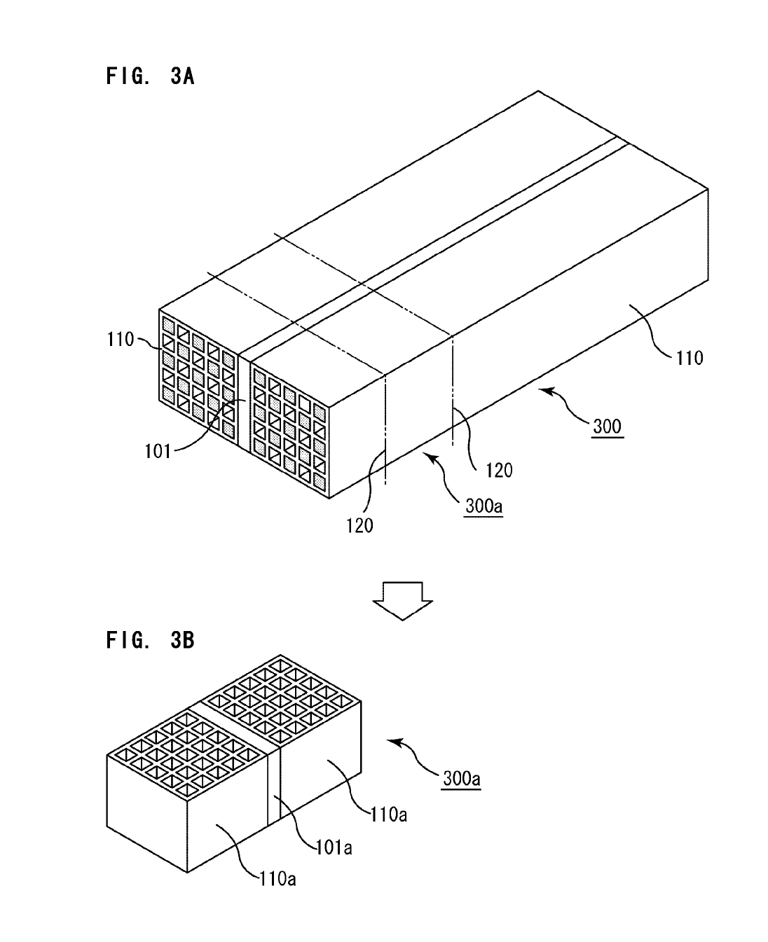

FIG. 3A is a perspective view that shows a method for bonding the honeycomb fired bodies, and FIG. 3B is a perspective view that shows a sample for evaluation prepared by cutting the bonded honeycomb fired bodies.

Each of total four cardboard spacers having a thickness of 1.0 mm was attached to each of the vicinities of the four corners of a side surface of one of honeycomb fired bodies 110. The spacer was attached to a position where the shortest distances from peripheral portions of the spacer to the two sides forming the corner of the side surface of the honeycomb fired body were both 4.5 mm.

Next, the sealing material for a honeycomb structure prepared in Examples and Comparative Examples was applied on the side surface of the honeycomb fired body 110 to which the spacer was attached. Another honeycomb fired body 110 was then bonded to the first honeycomb fired body 110 with the spacer and the sealing material for a honeycomb structure interposed therebetween. Thereafter the two honeycomb fired bodies 110 bonded with each other with the sealing material for a honeycomb structure interposed therebetween were heated at 120° C. to solidify the sealing material for a honeycomb structure so that an adhesive layer 101 having a thickness of 1.0 mm was formed.

Accordingly, a bonded body 300 including the two honeycomb fired bodies 110 and the adhesive layer 101 was manufactured (see FIG. 3A).

Next, the bonded body 300 was cut with a cutting disk at the positions shown by the chain double-dashed lines 120 so that the two bonded honeycomb fired bodies 110 has a length in the longitudinal direction of 25.0±1.0 mm. Accordingly, a sample for evaluation 300a including two pieces of honeycomb fired bodies 110a and an adhesive layer 101a obtained by the cutting was prepared (see FIG. 3B). The sample for evaluation 300a was prepared by cutting the bonded body 300 so that the sample for evaluation 300a did not include the spacer.

### (Evaluation Based on Breaking Strength)

Using the samples for evaluation 300a, breaking strength of the respective sealing materials for a honeycomb structure (adhesive layer 101a) was measured according to the methods mentioned below. The obtained breaking strength served as the index of the bonding strength of the sealing materials for a honeycomb structure.

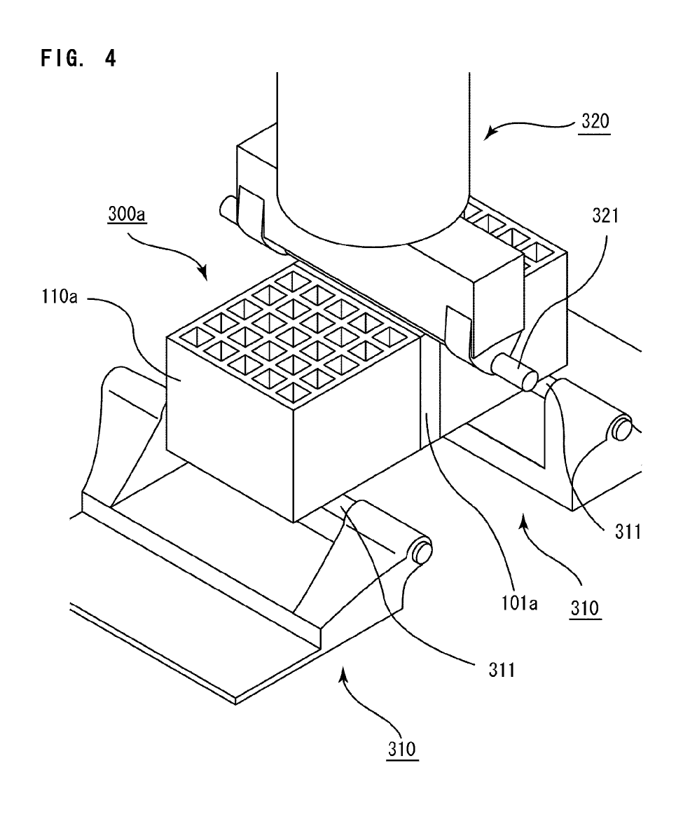

FIG. 4 is a perspective view that schematically shows a method for measuring the breaking strength of the sealing material for a honeycomb structure (the adhesive layer 101a) in the sample for evaluation 300a.

A load was applied to a portion of the adhesive layer 101a formed between the two pieces of the honeycomb fired bodies 110a. The load at the time when the adhesive layer 101a was broken was set as the breaking strength. The breaking strength was measured with a bending tensile testing machine (Instron 5582) by a three-point bent test with reference to JIS R 1601.

The contents of JIS R 1601 are incorporated herein by reference in their entirety.

As shown in FIG. 4, two lower jigs 310 each having a cylindrical sample supporting rod 311 were fixed to a fixed table of the Instron testing machine, with the sample supporting rods 311 each disposed at the upper side of the lower jig 310 and having a distance (span distance) of 56 mm between them.

The sample for evaluation 300a obtained in the foregoing process was placed to bridge the sample supporting rods 311 of the two lower jigs 310 in such a manner that the adhesive layer 101a in the sample for evaluation 300a was located in the middle between the center of the two supporting rods 311.

Next, position of the upper jig 320 was controlled so that a cylindrical sample contacting portion 321 of the upper jig 320, when it was lowered, was placed above the center portion of the adhesive layer 101a. Then, the upper jig 320 was lowered to allow the sample contacting portion 321 to contact with the surface of the adhesive layer 101a. The upper jig 320 was further lowered at a rate of 1.0 mm/min until breakage occurred in the adhesive layer 101a. The load at the time when the breakage occurs was set as the breaking strength (kgf).

Tables 2 and 3 show the results of the measurements of the breaking strength of the sealing material for a honeycomb structure (the adhesive layer).

### (Manufacturing of Honeycomb Structure)

On a base having a V-shaped cross section, a honeycomb fired body was placed along the V-shaped cut surface. The sealing material for a honeycomb structure according to Examples was applied on the honeycomb fired body on its side surface facing upward using a squeegee so that an adhesive paste layer was formed.

On the adhesive paste layer, each of total four spacers was placed on each of the vicinities of the four corners of the aforementioned side surface.

Specifically, each of spacers was placed at a position where the shortest distances from peripheral portions of the spacer to the two sides forming the corner of the side surface of the honeycomb fired body were both 4.5 mm.

Thereafter, other honeycomb fired body was placed on the adhesive paste layer and the spacers. The sealing material for a honeycomb structure was applied on a side surface of the other honeycomb fired body, followed by placement of other spacers and then a next honeycomb fired body. By repeating the foregoing process, a honeycomb aggregated body, in which the honeycomb fired bodies were arranged in four columns and four rows, was manufactured.

The thickness (distance between the honeycomb fired bodies) of the adhesive paste layer was controlled to be 1.0 mm.

Further, by heating the honeycomb aggregated body at 120° C., the adhesive paste layer was solidified to be made into an adhesive layer. Accordingly, a ceramic block was manufactured.

The outer periphery of the ceramic block was cut with a diamond cutter into a round pillar shape.

Next, a peripheral sealing material paste layer having a thickness of 0.2 mm was formed on the periphery of the ceramic block using the sealing material for a honeycomb structure according to Examples.

By drying the peripheral sealing material paste layer at 120° C., a honeycomb structure having a round pillar shape with a diameter of 132.5 mm and a height of 150 mm, in which the peripheral sealing material layer was formed on the periphery of the ceramic block was manufactured.

The thus obtained honeycomb structure sufficiently exerts functions as a filter for an exhaust gas purifying apparatus.

Tables 2 and 3 collectively show kinds of the inorganic fibers, kinds and blending amounts of the ion adsorbents, kinds and blending amounts of the oxide sols, pH values of the sealing materials for a honeycomb structure, and evaluation results of the time course changes in the viscosity and evaluation results of the breaking strength, which were used or obtained in the sealing materials for a honeycomb structure of Examples 1 to 20 and Comparative Examples 1 to 3.

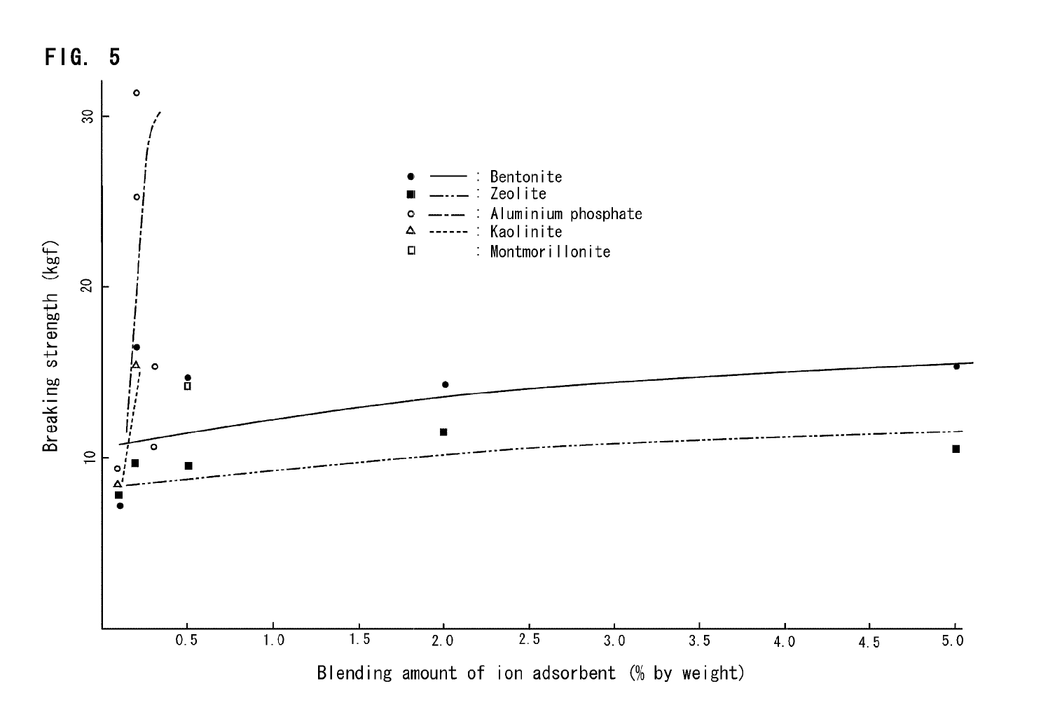

FIG. 5 is a graph that shows relations between the blending amount of each of the ion adsorbents and the breaking strength of the sealing materials for a honeycomb structure prepared in Examples 1 to 20 and Comparative Examples 1 to 3.

TABLE 2

| | | | | | | | Results of evaluation | | | | |
|---|---|---|---|---|---|---|---|---|---|---|---|
| | | Ion adsorbent | | Oxide sol | | | Viscosity (Pa · S) | | | | |
| | Inorganic | | Blending | | Blending | | Immediately | | | | Breaking |
| | fibers | | amount | | amount | | after | 1 day | 3 days | 7 days | strength |
| | Kinds | Kinds | (% by weight) | Kinds | (% by weight) | pH | preparation | after | after | after | kgf |
| Example 1 | A | Bentonite | 0.5 | — | — | 6.3 | 31.2 | 36.5 | 36.3 | 36.7 | 14.9 |
| Example 2 | A | Bentonite | 0.2 | — | — | 6.5 | 29.3 | 29.6 | 30.0 | 30.4 | 16.6 |
| Example 3 | A | Bentonite | 0.1 | — | — | 6.5 | 34.3 | 39.6 | 39.8 | 40.9 | 7.1 |
| Example 4 | A | Bentonite | 2.0 | — | — | 6.3 | 30.4 | 37.6 | 38.1 | 38.8 | 14.2 |
| Example 5 | A | Bentonite | 5.0 | — | — | 6.6 | 30.6 | 37.1 | 39.1 | 39.3 | 15.2 |
| Example 6 | A | Bentonite | 0.5 | Acidic | 20 | 6.4 | 31.6 | 31.4 | 31.8 | 33.2 | 13.8 |
| | | | | silica sol | | | | | | | |
| Example 7 | A | Bentonite | 0.5 | Alkaline | 20 | 8.2 | 30.4 | 31.8 | 34.9 | 35.2 | 12.3 |
| | | | | silica sol | | | | | | | |
| Example 8 | A | Montmo- | 0.5 | — | — | 6.6 | 32.6 | 36.1 | 36.6 | 36.8 | 14.3 |
| | | rillonite | | | | | | | | | |
| Example 9 | A | Kaolinite | 0.1 | — | — | 6.4 | 35.6 | 38.2 | 39.1 | 40.3 | 8.4 |
| Example 10 | A | Kaolinite | 0.2 | — | — | 6.5 | 30.5 | 31.1 | 31.6 | 31.8 | 15.7 |
| Comparative | A | — | 0 | Acidic | 20 | 6.7 | 36.1 | 42.3 | 42.3 | 43.2 | 4.5 |
| Example 1 | | | | silica sol | | | | | | | |
| Comparative | A | — | 0 | Alkaline | 20 | 8.4 | 30.2 | 300 | — | — | — |
| Example 2 | | | | silica sol | | | | | | | |

TABLE 3

| | | | | | | | Results of evaluation | | | | |
|---|---|---|---|---|---|---|---|---|---|---|---|
| | | Ion adsorbent | | Oxide sol | | | Viscosity (Pa · S) | | | | |
| | Inorganic | | Blending | | Blending | | Immediately | | | | Breaking |
| | fibers | | amount | | amount | | after | 1 day | 3 days | 7 days | strength |
| | Kinds | Kinds | (% by weight) | Kinds | (% by weight) | pH | preparation | after | after | after | kgf |
| Example 11 | A | Zeolite | 0.5 | — | — | 8.4 | 36.1 | 185.5 | 300 | — | 9.6 |
| Example 12 | A | Zeolite | 0.1 | — | — | 8.5 | 36.7 | 99.1 | 300 | — | 7.8 |
| Example 13 | A | Zeolite | 0.2 | — | — | 8.5 | 34.3 | 170.9 | 300 | — | 9.9 |
| Example 14 | A | Zeolite | 2.0 | — | — | 8.5 | 37.8 | 79.1 | 300 | — | 11.5 |
| Example 15 | A | Zeolite | 5.0 | — | — | 8.4 | 36.9 | 70.8 | 300 | — | 10.6 |
| Example 16 | A | Aluminium | 0.10 | Alkaline | 20 | 3.8 | 36.4 | 40.6 | 41.9 | 300 | 9.4 |
| | | phosphate | | silica sol | | | | | | | |
| Example 17 | A | Aluminium | 0.25 | Alkaline | 20 | 4.6 | 34.5 | 38.6 | 38.9 | 39.1 | 15.3 |
| | | phosphate | | silica sol | | | | | | | |
| Example 18 | A | Aluminium | 0.20 | Alkaline | 20 | 3.7 | 35.1 | 36.7 | 38.1 | 38.6 | 25.5 |
| | | phosphate | | silica sol | | | | | | | |
| Example 19 | A | Aluminium | 0.25 | Acidic | 20 | 2.5 | 34.3 | 36.4 | 36.7 | 37.1 | 10.8 |
| | | phosphate | | silica sol | | | | | | | |
| Example 20 | A | Aluminium | 0.25 | — | — | 0.7 | 35.8 | 34.2 | 34.4 | 34.5 | 32.1 |
| | | phosphate | | | | | | | | | |
| Comparative | A | Aluminium | 0.07 | — | — | 5.7 | 34.1 | 300 | — | — | 6.2 |
| Example 3 | | phosphate | | | | | | | | | |

As shown in Table 2, from the results of the viscosity of the obtained sealing materials (paste) for a honeycomb structure, it is assumed that the sealing materials for a honeycomb structure (in Examples 1 to 10) containing, as an ion adsorbent, from 0.1 to 5.0% by weight of a clay ion adsorbent such as bentonite, montmorillonite or kaolinite did not increase the viscosity even a week later, and further the breaking strength of the samples for evaluation was high, and thus the sealing materials for a honeycomb structure were more likely to be favorably used as a sealing material for a honeycomb structure. It was also assumed that, in the case where the sealing material for a honeycomb structure contained, as an ion adsorbent, 0.1% by weight of bentonite or kaolinite, the breaking strength of the evaluation sample was slightly low but at an acceptable level, and in the case where the sealing material for a honeycomb structure contained 0.2% by weight or more of the aforementioned adsorbent, the breaking strength was increased.

On the other hand, in the case where the sealing material for a honeycomb structure (in Comparative Example 1) contained no ion adsorbent, the viscosity thereof was gradually increased or breaking strength of the evaluation sample was low. In the sealing material for a honeycomb structure (in Comparative Example 2) contained no ion adsorbent, the viscosity thereof become high after a lapse of one day. From those results, it is assumed that the sealing materials might not be favorably used as a sealing material for a honeycomb structure.

Moreover, as shown in Table 3, it is assumed that, in the case where the sealing materials for a honeycomb structure (in Examples 11 to 15) contained from 0.1 to 5.0% by weight of zeolite as an ion adsorbent, the breaking strength of the evaluation samples was high. Moreover, it is assumed that, in the case where the sealing materials for a honeycomb structure (in Examples 16 to 20) contained from 0.10 to 0.25% by weight of aluminum phosphate as an ion adsorbent, the viscosity thereof did not increase for along period of time and the breaking strength of the evaluation samples showed radical increase as the blending amount of the ion adsorbent was increased. From those results, it is assumed that those sealing materials for a honeycomb structure tend to be favorably used as a sealing material for a honeycomb structure.

On the other hand, it is assumed that, in the case where the sealing material for a honeycomb structure (in Comparative Example 3) contained 0.07% by weight of aluminum phosphate, the viscosity thereof became high after a lapse of one day, and the breaking strength of the evaluation sample was low. From this result, it is assumed that the sealing material for a honeycomb structure might not be favorably used as a sealing material for a honeycomb structure.

Although the foregoing results are those obtained when the inorganic fibers “A” shown in Table 1 were used, the same results were obtained when replacing the inorganic fibers “A” with the inorganic fibers “B”.

Presumably, use of silica adsorbents, alumina adsorbents, zeolite adsorbents (e.g. aluminosilicate zeolite, metallosilicate zeolite, aluminophosphate zeolite), or polyvalent metal salts (e.g. iron phosphate, magnesium phosphate, and aluminum fluoride) as an ion adsorbents may produce the same results as those obtained in the foregoing Examples and Comparative Examples.

### Other Embodiments

In the first embodiment, a ceramic block is manufactured by forming an adhesive paste layer on a predetermined side surface of each of the honeycomb fired bodies, successively placing other honeycomb fired bodies on the adhesive paste layer, repeating the foregoing forming and placing, solidifying the adhesive paste to form the adhesive layer, and then performing periphery cutting. In one of other embodiments, the ceramic block may be manufactured by the method mentioned below.

First, a plurality of honeycomb fired bodies are placed in parallel with one another in columns and rows, with a spacer interposed therebetween so that a parallel-arranged body of honeycomb fired bodies is produced. The spacer is designed to have substantially the same thickness as the thickness of the adhesive layer to be formed between the honeycomb fired bodies. As a result, a gap corresponding to the thickness of the spacer is formed between the honeycomb fired bodies.

Successively, the gap formed between the honeycomb fired bodies placed in parallel with one another is filled in with the sealing material for a honeycomb structure described in the first embodiment by using a filling apparatus.

In filling the gap formed between the honeycomb fired bodies with the sealing material for a honeycomb structure described in the first embodiment, the parallel-arranged body of honeycomb fired bodies is placed inside the inner space of a tubiform, and the sealing material paste supply unit is set up to the end face of the tubiform. Then, the sealing material for a honeycomb structure described in the first embodiment is extruded from a paste chamber of the sealing material paste supply unit by using an extruding mechanism to fill the gap between the honeycomb fired bodies.

By these methods, a laminated body of the honeycomb fired bodies having the plurality of honeycomb fired bodies with the gap filled with the sealing material for a honeycomb structure as an adhesive can be manufactured.

Successively, the laminated body of the honeycomb fired bodies is heated by using a drying apparatus or the like to dry and solidify the adhesive so that an adhesive layer is formed. Periphery cutting is then performed on the resulting product. Through these processes, a ceramic block can be manufactured.

Furthermore, a honeycomb structure maybe manufactured in the method mentioned below according to one of the other embodiments.

Namely, three kinds of honeycomb fired bodies having almost the same shapes as those of the honeycomb fired bodies constituting the honeycomb structure shown in FIG. 1 are prepared. These three kinds of honeycomb fired bodies having mutually different cross-sectional shapes can be prepared by altering the shape of a die to be used for extrusion-molding. In the honeycomb fired body shown in FIG. 1, a plurality of the cells are exposed by cutting. On the other hand, in the honeycomb fired body prepared by extrusion molding, the plurality of the cells are not exposed and a cell wall is formed on the periphery of the honeycomb fired body.

Thereafter, a plurality of these three kinds of honeycomb fired bodies are placed in columns and rows in parallel with one another, with a spacer interposed therebetween, to form a parallel-arranged body of honeycomb fired bodies having a virtually round shape in its cross-section perpendicular to the longitudinal direction. At this time, a gap having a thickness of the spacer is formed between the respective honeycomb fired bodies.

Successively, the parallel-arranged body of honeycomb fired bodies is placed in a filling apparatus having a cylindrical tubiform, and a gap formed between the honeycomb fired bodies and a gap formed between the honeycomb fired bodies and the tubiform were filled in with a sealing material for a honeycomb structure described in the foregoing first embodiment.

A filling apparatus used in the present embodiment is provided with the cylindrical tubiform and a sealing material paste supply unit. The tubiform has a slightly larger inner diameter than the diameter of the parallel-arranged body of honeycomb fired bodies to be placed in the tubiform. Therefore, when the parallel-arranged body of honeycomb fired bodies is placed in the inner space of the tubiform, a gap is formed between the tubiform and the parallel-arranged body of honeycomb fired bodies.

The sealing material paste supply unit is configured to have a structure which enables simultaneously filling the gap between the honeycomb fired bodies and the gap between the tubiform and the parallel-arranged body of the honeycomb fired bodies with the sealing material for a honeycomb structure described in the foregoing first embodiment, which is stored in the sealing material paste chamber.

According to the method mentioned earlier, the gap formed between the honeycomb fired bodies and the gap formed between the honeycomb fired bodies and the tubiform are filled in with the sealing material for a honeycomb structure explained in the first embodiment and then the sealing material for a honeycomb structure is solidified so that a honeycomb structure is manufactured. In this manner, the adhesive layer and the peripheral sealing material layer can be simultaneously formed.

The cross-sectional shape of the honeycomb fired bodies is not limited to the three kinds, and the cross-section may have multiple kinds of shapes.

Moreover, in one of the other embodiments, a honeycomb structure can be manufactured not by binding a plurality of the honeycomb fired bodies to form a ceramic block, but by applying the sealing material for a honeycomb structure described in the first embodiment on the periphery of a single piece of a cylindrical honeycomb fired body which functions as a ceramic block, followed by solidification of the sealing material for a honeycomb structure.

According to the honeycomb structure according to the embodiment of the present invention, the sealing material for a honeycomb structure to be used for forming the adhesive layer and the sealing material for a honeycomb structure to be used for forming the peripheral sealing material layer may be made of the same materials or different materials.

As for the adhesive, adhesive pastes that have been conventionally used for manufacturing the honeycomb structure may be used as well as the sealing material for a honeycomb structure according to the embodiment of the present invention.

Although not particularly limited, the shape of the honeycomb fired bodies that constitute the honeycomb structure according to the embodiment of the present invention is preferably designed to easily bond the honeycomb fired bodies with one another when manufacturing a honeycomb structure. For example, a shape having a substantially square, substantially rectangular, substantially hexagonal, substantially sector shape and the like in its cross-section may be used.

The shape of the honeycomb structure according to the embodiment of the present invention is not particularly limited to a substantially round pillar shape, and may be a desired pillar shape such as a substantially cylindroid shape, a pillar shape with a substantially racetrack end face, and a substantially polygonal pillar shape.

Although not particularly limited, the porosity of the honeycomb fired body that constitutes the honeycomb structure according to the embodiment of the present invention is preferably from about 35% to about 60%.

When the honeycomb structure manufactured by using the aforementioned honeycomb fired body is used as a filter, the porosity of the honeycomb fired body of about 35% or more tends not to cause clogging in the filter. On the other hand, the porosity of the honeycomb fired body of about 60% or less is tends not to cause a reduction in the strength of the honeycomb fired body, resulting in rarely breakage of the filter.

The average pore diameter of the honeycomb fired body that constitutes the honeycomb structure according to the embodiment of the present invention is preferably from about 5 μm to about 30 μm.

When the honeycomb structure manufactured by using the aforementioned honeycomb fired body is used as a filter, the average pore diameter of the honeycomb fired body of about 5 μm or more tends not to cause clogging in the filter. On the other hand, the average pore diameter of the honeycomb fired body of about 30 μm or less tends not to allow particulates to easily pass through the pores. As a result, the honeycomb fired body is more likely to capture the particulates, which enables functioning as a filter.

The porosity and the pore diameter can be measured through conventionally known methods such as a mercury porosimetry, Archimedes method, and a measuring method using a scanning electronic microscope (SEM).

The cell density in the cross-section perpendicular to the longitudinal direction of the honeycomb fired body that constitutes the honeycomb structure according to the embodiment of the present invention is not particularly limited. A preferable lower limit of the cell density is about 3.10 pcs/cm² (about 200 pcs/inch²) and a preferable upper limit thereof is about 93.0 pcs/cm² (about 600 pcs/inch²). A more preferable lower limit of the cell density is about 38.8 pcs/cm² (about 250 pcs/inch²) and a more preferable upper limit thereof is about 77.5 pcs/cm² (about 500 pcs/inch²).

Further, the thickness of the cell walls of the honeycomb fired body that constitutes the honeycomb structure according to the embodiment of the present invention is not particularly limited, and preferably from about 0.1 mm to about 0.4 mm.

The main component of constituent materials of the honeycomb fired body that constitutes the honeycomb structure according to the embodiment of the present invention is not limited to silicon carbide. Examples of other ceramic materials include ceramic powders, for example, nitride ceramics such as aluminum nitride, silicon nitride, boron nitride and titanium nitride; carbide ceramics such as zirconium carbide, titanium carbide, tantalum carbide and tungsten carbide; oxide ceramics such as alumina, zirconia, cordierite, mullite, and aluminum titanate; and the like.

Non-oxide ceramics are preferable, and silicon carbide is more preferable among the above components, because they are excellent in thermal resistance properties, mechanical strength, thermal conductivity and the like. Moreover, examples of the constituent material of the honeycomb fired body also include silicon-containing ceramics, in which metallic silicon is blended with the foregoing ceramics, as well as a ceramic material such as ceramic in which the forgoing ceramics is bound by silicon or silicate compounds. The ceramics (silicon-containing silicon carbide) in which metallic silicon is blended with the silicon carbide are preferably used.

A silicon-containing silicon carbide ceramic containing about 60% by weight or more of silicon carbide is especially preferable.

The organic binder used when preparing the wet mixture used when manufacturing the honeycomb structure according to the embodiment of the present invention is not particularly limited, and examples thereof include methylcellulose, carboxymethylcellulose, hydroxyethylcellulose, polyethylene glycol and the like. Methylcellulose is preferable among the above examples. A blending amount of the organic binder is preferably from about 1 part by weight to about 10 parts by weight with respect to 100 parts by weight of ceramic powder.

The plasticizer used when preparing the wet mixture used when manufacturing the honeycomb structure according to the embodiment of the present invention is not particularly limited, and examples thereof include glycerin or the like. The lubricant is not particularly limited, and examples thereof include polyoxyalkylene-based compounds such as polyoxyethylene alkyl ether and polyoxypropylene alkyl ether, or the like. Specific examples of the lubricant include polyoxyethylene monobutyl ether, polyoxypropylene monobutyl ether and the like.

Moreover, the plasticizer and the lubricant may optionally not be contained in the wet mixture.

In addition, a dispersant solution may be used upon preparing a wet mixture used when manufacturing the honeycomb structure according to the embodiment of the present invention, and examples of the dispersant solution include water, an organic solvent such as benzene, alcohol such as methanol and the like.

Moreover, a molding auxiliary may be added to the wet mixture used when manufacturing the honeycomb structure according to the embodiment of the present invention.

The molding auxiliary is not particularly limited, and examples thereof include ethylene glycol, dextrin, fatty acid, fatty acid soap, polyalcohol and the like.

Furthermore, a pore-forming agent such as balloons that are fine hollow spheres including oxide-based ceramics, spherical acrylic particles, graphite and the like may be added to the wet mixture used when manufacturing the honeycomb structure according to the embodiment of the present invention, if necessary.

The balloon is not particularly limited, and examples thereof include alumina balloon, glass micro balloon, shirasu balloon, fly ash balloon (FA balloon), mullite balloon and the like. Alumina balloon is preferable among the above examples.

The plug material paste, used when manufacturing the honeycomb structure according to the embodiment of the present invention, for plugging the cells is not particularly limited, a plug to be manufactured through the subsequent processes preferably has a porosity of from about 30% to about 75%, and for example, it is possible to use a plug material paste having the same composition as that of the wet mixture of the raw material.

The catalyst to convert and/or purify exhaust gases may be supported on the honeycomb structure according to the embodiment of the present invention, and preferable examples of the catalyst to be supported include noble metals such as platinum, palladium and rhodium. Platinum is more preferable among these. Moreover, an alkali metal such as sodium and potassium, and an alkaline earth metal such as barium may be used as other catalysts. These catalysts may be used alone, or two or more kinds of these may be used in combination.

The above description has only discussed the honeycomb structure (honeycomb filter) in which either one end portion of each of the cells is plugged. However, the honeycomb structure according to the embodiment of the present invention does not always need to have an end portion of each cell plugged, and such honeycomb structures according to the embodiment of the present invention may be preferably used as a catalyst supporting carrier.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A sealing material for a honeycomb structure, comprising:
inorganic fibers comprising a biosoluble inorganic compound;
inorganic particles; and
an ion adsorbent in an amount of about 0.1%by weight or more.

2. The sealing material according to claim 1,
wherein
the inorganic compound comprises at least one of alkali metal compounds and alkaline earth metal compounds.

3. The sealing material according to claim 1,
wherein
the ion adsorbent comprises at least one of silica adsorbents, alumina adsorbents, zeolite adsorbents, clay adsorbents, mesoporous adsorbents, polyvalent metal salts, and activated carbon.

4. The sealing material according to claim 3,
wherein
the ion adsorbent comprises a clay adsorbent.

5. The sealing material according to claim 4,
wherein
the clay adsorbent comprises at least one of bentonite, activated white clay, and montmorillonite.

6. The sealing material according to claim 4,
wherein
the clay adsorbent comprises at least one of kaolinite, acid clay, halloysite, sericite, and mica clay minerals.

7. The sealing material according to claim 3,
wherein
the ion adsorbent comprises at least one of a zeolite adsorbent and activated carbon.

8. The sealing material according to claim 7,
wherein
the zeolite adsorbent comprises at least one of alminosilicate zeolite, metallosilicate zeolite, and aluminophosphate zeolite.

9. The sealing material according to claim 3,
wherein
the ion adsorbent comprises a polyvalent metal salt.

10. The sealing material according to claim 9,
wherein
the polyvalent metal salt comprises at least one of aluminum phosphate, iron phosphate, magnesium phosphate, and aluminum fluoride.

11. The sealing material according to claim 3,
wherein
the ion adsorbent comprises a silica adsorbent, and
the silica adsorbent comprises at least one of silica gel, aero gel, colloidal silica, and porous silicate glass.

12. The sealing material according to claim 3,
wherein
the ion adsorbent comprises an almina adsorbent, and
the almina adsorbent comprises an activated alumina.

13. The sealing material according to claim 12,
wherein
the activated alumina comprises at least one of α-alumina, γ-alumina, δ-alumina, and θ-alumina.

14. The sealing material according to claim 3,
wherein
the ion adsorbent comprises a mesoporous adsorbent, and
the mesoporous adsorbent comprises at least one of mesoporous silica, mesoporous silica-alumina, mesoporous titania, and mesoporous zirconia.

15. The sealing material according to claim 1,
wherein
the amount of the ion adsorbent in the sealing material for the honeycomb structure is about 0.2% by weight or more.

16. The sealing material according to claim 1,
wherein
the amount of the ion adsorbent in the sealing material for the honeycomb structure is about 5.0% by weight or less.

17. The sealing material according to claim 1,
wherein
the ion adsorbent comprises at least one of a bentonite and a zeolite adsorbent, and
a content of the ion adsorbent in the sealing material for the honeycomb structure is from about 0.2% by weight to about 2.0% by weight.

18. The sealing material according to claim 1,
wherein
the ion adsorbent comprises an aluminum phosphate, and
a content of the ion adsorbent in the sealing material for the honeycomb structure is from about 0.1%by weight to about 2.0% by weight.

19. The sealing material according to claim 1,
wherein
a weight ratio of the ion adsorbent to the inorganic fibers (weight of inorganic fibers/weight of ion adsorbent) in the sealing material for the honeycomb structure is from about 100/1 to about 4/1.

20. The sealing material according to claim 1,
wherein
an average fiber length of the inorganic fibers is from about 0.1 μm to about 1000 μm.

21. The sealing material according to claim 1,
wherein
an amount of silica contained in the inorganic fibers is from about 60% by weight to about 85% by weight.

22. The sealing material according to claim 1,
wherein
an amount of Al₂O₃ contained in the inorganic fibers is about 2% by weight or less.

23. The sealing material according to claim 1,
wherein
an amount of the inorganic fibers contained in the sealing material for the honeycomb structure is from about 10% by weight to about 70% by weight.

24. The sealing material according to claim 1,
wherein
an average particle diameter of the inorganic particles is from about 0.01 μm to about 100 μm.

25. The sealing material according to claim 2,
wherein
the alkali metal compounds comprise at least one of sodium oxides, sodium salts, potassium oxides, and potassium salts, and
the alkaline earth metal compounds comprise at least one of magnesium oxides, magnesium salts, calcium oxides, calcium salts, barium oxides, and barium salts.

26. The sealing material according to claim 1, further comprising an oxide sol.

27. The sealing material according to claim 26,
wherein
the oxide sol comprises at least one of silica sol, alumina sol, and zirconia sol.

28. The sealing material according to claim 26,
wherein
an amount of the oxide sol contained in the sealing material for the honeycomb structure is from about 1% by weight to about 30% by weight as a solid content.

29. The sealing material according to claim 26,
wherein
an average particle diameter of the oxide included in the oxide sol is from about 5 nm to about 30 nm.

30. The sealing material according to claim 26,
wherein
the sealing material for the honeycomb structure is alkaline.

31. The sealing material according to claim 1,
wherein
the sealing material for the honeycomb structure is acidic.

32. The sealing material according to claim 1,
wherein
a pH value of the sealing material for the honeycomb structure is from about 4 to about 7.

33. A honeycomb structure comprising:
a ceramic block comprising a honeycomb fired body in which a plurality of through holes are longitudinally formed with a partition wall interposed therebetween; and
a peripheral sealing material layer formed on a peripheral surface of the ceramic block,
wherein
the peripheral sealing material layer is formed by solidifying a sealing material for the honeycomb structure, the sealing material for the honeycomb structure comprising:
inorganic fibers comprising a biosoluble inorganic compound;
inorganic particles; and
an ion adsorbent in an amount of about 0.1% by weight or more.

34. The honeycomb structure according to claim 33,
wherein
the inorganic compound in the sealing material for the honeycomb structure comprises at least one of alkali metal compounds and alkaline earth metal compounds.

35. The honeycomb structure according to claim 33,
wherein
the ion adsorbent in the sealing material for the honeycomb structure comprises at least one of silica adsorbents, alumina adsorbents, zeolite adsorbents, clay adsorbents, mesoporous adsorbents, polyvalent metal salts, and activated carbon.

36. The honeycomb structure according to claim 35,
wherein
the ion adsorbent in the sealing material for the honeycomb structure comprises a clay adsorbent.

37. The honeycomb structure according to claim 36,
wherein
the clay adsorbent comprises at least one of bentonite, activated white clay, and montmorillonite.

38. The honeycomb structure according to claim 36,
wherein
the clay adsorbent comprises at least one of kaolinite, acid clay, halloysite, sericite, and mica clay minerals.

39. The honeycomb structure according to claim 35,
wherein
the ion adsorbent in the sealing material for the honeycomb structure comprises at least one of a zeolite adsorbent and activated carbon.

40. The honeycomb structure according to claim 39,
wherein
the zeolite adsorbent comprises at least one of alminosilicate zeolite, metallosilicate zeolite, and aluminophosphate zeolite.

41. The honeycomb structure according to claim 35,
wherein
the ion adsorbent in the sealing material for the honeycomb structure comprises a polyvalent metal salt.

42. The honeycomb structure according to claim 41,
wherein
the polyvalent metal salt comprises at least one of aluminum phosphate, iron phosphate, magnesium phosphate, and aluminum fluoride.

43. The honeycomb structure according to claim 35,
wherein
the ion adsorbent in the sealing material for the honeycomb structure comprises a silica adsorbent, and
the silica adsorbent comprises at least one of silica gel, aero gel, colloidal silica, and porous silicate glass.

44. The honeycomb structure according to claim 35,
wherein
the ion adsorbent in the sealing material for the honeycomb structure comprises an almina adsorbent, and
the almina adsorbent comprises an activated alumina.

45. The honeycomb structure according to claim 44,
wherein
the activated alumina comprises at least one of α-alumina, γ-alumina, δ-alumina, and θ-alumina.

46. The honeycomb structure according to claim 35,
wherein
the ion adsorbent in the sealing material for the honeycomb structure comprises a mesoporous adsorbent, and
the mesoporous adsorbent comprises at least one of mesoporous silica, mesoporous silica-alumina, mesoporous titania, and mesoporous zirconia.

47. The honeycomb structure according to claim 33,
wherein
the amount of the ion adsorbent in the sealing material for the honeycomb structure is about 0.2% by weight or more.

48. The honeycomb structure according to claim 33,
wherein
the amount of the ion adsorbent in the sealing material for the honeycomb structure is about 5.0% by weight or less.

49. The honeycomb structure according to claim 33,
wherein
the ion adsorbent in the sealing material for the honeycomb structure comprises at least one of a bentonite and a zeolite adsorbent, and
a content of the ion adsorbent in the sealing material for the honeycomb structure is from about 0.2% by weight to about 2.0% by weight.

50. The honeycomb structure according to claim 33,
wherein
the ion adsorbent in the sealing material for the honeycomb structure comprises an aluminum phosphate, and
a content of the ion adsorbent in the sealing material for the honeycomb structure is from about 0.1%by weight to about 2.0% by weight.

51. The honeycomb structure according to claim 33,
wherein
a weight ratio of the ion adsorbent to the inorganic fibers (weight of inorganic fibers/weight of ion adsorbent) in the sealing material for the honeycomb structure is from about 100/1 to about 4/1.

52. The honeycomb structure according to claim 33,
wherein
an average fiber length of the inorganic fibers in the sealing material for the honeycomb structure is from about 0.1 μm to about 1000 μm.

53. The honeycomb structure according to claim 33,
wherein
an amount of silica contained in the inorganic fibers in the sealing material for the honeycomb structure is from about 60% by weight to about 85% by weight.

54. The honeycomb structure according to claim 33,
wherein
an amount of Al₂O₃ contained in the inorganic fibers in the sealing material for the honeycomb structure is about 2% by weight or less.

55. The honeycomb structure according to claim 33,
wherein
an amount of the inorganic fibers contained in the sealing material for the honeycomb structure is from about 10% by weight to about 70% by weight.

56. The honeycomb structure according to claim 33,
wherein
an average particle diameter of the inorganic particles in the sealing material for the honeycomb structure is from about 0.01 μm to about 100 μm.

57. The honeycomb structure according to claim 34,
wherein
the alkali metal compounds in the sealing material for the honeycomb structure comprise at least one of sodium oxides, sodium salts, potassium oxides, and potassium salts, and
the alkaline earth metal compounds in the sealing material for the honeycomb structure comprise at least one of magnesium oxides, magnesium salts, calcium oxides, calcium salts, barium oxides, and barium salts.

58. The honeycomb structure according to claim 33,
wherein
the sealing material for the honeycomb structure further comprises an oxide sol.

59. The honeycomb structure according to claim 58,
wherein
the oxide sol comprises at least one of silica sol, alumina sol, and zirconia sol.

60. The honeycomb structure according to claim 58,
wherein
an amount of the oxide sol contained in the sealing material for the honeycomb structure is from about 1% by weight to about 30% by weight as a solid content.

61. The honeycomb structure according to claim 58,
wherein
an average particle diameter of the oxide included in the oxide sol is from about 5 nm to about 30 nm.

62. The honeycomb structure according to claim 58,
wherein
the sealing material for the honeycomb structure is alkaline.

63. The honeycomb structure according to claim 33,
wherein
the sealing material for the honeycomb structure is acidic.

64. The honeycomb structure according to claim 33,
wherein
a pH value of the sealing material for the honeycomb structure is from about 4 to about 7.

65. The honeycomb structure according to claim 33,
wherein the ceramic block comprises
a plurality of the honeycomb fired bodies, and
an adhesive layer formed between side surfaces of the plurality of the honeycomb fired bodies.

66. The honeycomb structure according to claim 65,
wherein
the adhesive layer is formed by solidifying an adhesive.

67. The honeycomb structure according to claim 66,
wherein
the adhesive comprises a sealing material for the honeycomb structure, the sealing material for the honeycomb structure comprising:
inorganic fibers comprising a biosoluble inorganic compound;
inorganic particles; and
an ion adsorbent in an amount of about 0.1% by weight or more.

68. The honeycomb structure according to claim 67,
wherein
the inorganic compound in the adhesive comprises at least one of alkali metal compounds and alkaline earth metal compounds.

69. The honeycomb structure according to claim 67,
wherein
the ion adsorbent in the adhesive comprises at least one of silica adsorbents, alumina adsorbents, zeolite adsorbents, clay adsorbents, mesoporous adsorbents, polyvalent metal salts, and activated carbon.

70. The honeycomb structure according to claim 69,
wherein
the ion adsorbent in the adhesive comprises a clay adsorbent.

71. The honeycomb structure according to claim 70,
wherein
the clay adsorbent comprises at least one of bentonite, activated white clay, and montmorillonite.

72. The honeycomb structure according to claim 70,
wherein
the clay adsorbent comprises at least one of kaolinite, acid clay, halloysite, sericite, and mica clay minerals.

73. The honeycomb structure according to claim 69,
wherein
the ion adsorbent in the adhesive comprises at least one of a zeolite adsorbent and activated carbon.

74. The honeycomb structure according to claim 73,
wherein
the zeolite adsorbent comprises at least one of alminosilicate zeolite, metallosilicate zeolite, and aluminophosphate zeolite.

75. The honeycomb structure according to claim 69,
wherein
the ion adsorbent in the adhesive comprises a polyvalent metal salt.

76. The honeycomb structure according to claim 75,
wherein
the polyvalent metal salt comprises at least one of aluminum phosphate, iron phosphate, magnesium phosphate, and aluminum fluoride.

77. The honeycomb structure according to claim 69,
wherein
the ion adsorbent in the adhesive comprises a silica adsorbent, and
the silica adsorbent comprises at least one of silica gel, aero gel, colloidal silica, and porous silicate glass.

78. The honeycomb structure according to claim 69,
wherein
the ion adsorbent in the adhesive comprises an almina adsorbent, and
the almina adsorbent comprises an activated alumina.

79. The honeycomb structure according to claim 78,
wherein
the activated alumina comprises at least one of α-alumina, γ-alumina, δ-alumina, and θ-alumina.

80. The honeycomb structure according to claim 69,
wherein
the ion adsorbent in the adhesive comprises a mesoporous adsorbent, and
the mesoporous adsorbent comprises at least one of mesoporous silica, mesoporous silica-alumina, mesoporous titania, and mesoporous zirconia.

81. The honeycomb structure according to claim 67,
wherein
the amount of the ion adsorbent in the adhesive is about 0.2% by weight or more.

82. The honeycomb structure according to claim 67,
wherein
the amount of the ion adsorbent in the adhesive is about 5.0% by weight or less.

83. The honeycomb structure according to claim 67,
wherein
the ion adsorbent in the adhesive comprises at least one of a bentonite and a zeolite adsorbent, and
a content of the ion adsorbent in the adhesive is from about 0.2% by weight to about 2.0% by weight.

84. The honeycomb structure according to claim 67,
wherein
the ion adsorbent in the adhesive comprises an aluminum phosphate, and
a content of the ion adsorbent in the adhesive is from about 0.1% by weight to about 2.0% by weight.

85. The honeycomb structure according to claim 67,
wherein
a weight ratio of the ion adsorbent to the inorganic fibers (weight of inorganic fibers/weight of ion adsorbent) in the adhesive is from about 100/1 to about 4/1.

86. The honeycomb structure according to claim 67,
wherein
an average fiber length of the inorganic fibers in the adhesive is from about 0.1 μm to about 1000 μm.

87. The honeycomb structure according to claim 67,
wherein
an amount of silica contained in the inorganic fibers in the adhesive is from about 60% by weight to about 85% by weight.

88. The honeycomb structure according to claim 67,
wherein
an amount of Al₂O₃ contained in the inorganic fibers in the adhesive is about 2% by weight or less.

89. The honeycomb structure according to claim 67,
wherein
an amount of the inorganic fibers contained in the adhesive is from about 10% by weight to about 70% by weight.

90. The honeycomb structure according to claim 67,
wherein
an average particle diameter of the inorganic particles in the adhesive is from about 0.01 μm to about 100 μm.

91. The honeycomb structure according to claim 68,
wherein
the alkali metal compounds in the adhesive comprise at least one of sodium oxides, sodium salts, potassium oxides, and potassium salts, and
the alkaline earth metal compounds in the adhesive comprise at least one of magnesium oxides, magnesium salts, calcium oxides, calcium salts, barium oxides, and barium salts.

92. The honeycomb structure according to claim 67,
wherein
the adhesive further comprises an oxide sol. 25

93. The honeycomb structure according to claim 92,
wherein
the oxide sol comprises at least one of silica sol, alumina sol, and zirconia sol.

94. The honeycomb structure according to claim 92,
wherein
an amount of the oxide sol contained in the adhesive is from about 1% by weight to about 30% by weight as a solid content .

95. The honeycomb structure according to claim 92,
wherein
an average particle diameter of the oxide included in the oxide sol is from about 5 nm to about 30 nm.

96. The honeycomb structure according to claim 92,
wherein
the adhesive is alkaline.

97. The honeycomb structure according to claim 67,
wherein
the adhesive is acidic.

98. The honeycomb structure according to claim 67,
wherein
a pH value of the adhesive is from about 4 to about 7.

99. The honeycomb structure according to claim 33,
wherein
the ceramic block comprises a single honeycomb fired body.

100. The honeycomb structure according to claim 33, further comprising a catalyst.

101. The honeycomb structure according to claim 33,
wherein
either one end portion of each of the through holes is plugged.

102. The honeycomb structure according to claim 33,
wherein
an end portion of each of the through holes is not plugged.

103. A method for manufacturing a honeycomb structure, comprising:
molding ceramic materials to construct a honeycomb molded body in which a plurality of through holes are longitudinally formed with a partition wall interposed therebetween;
constructing a ceramic block comprising a honeycomb fired body obtained after heat treatment of the honeycomb molded body; and
solidifying a peripheral sealing material paste layer formed on a peripheral surface of the ceramic block to form a peripheral sealing material layer,
said method further comprising
preparing a sealing material for the honeycomb structure by mixing at least inorganic fibers comprising a biosoluble inorganic compound, inorganic particles, and an ion adsorbent in an amount of about 0.1% by weight or more,
the peripheral sealing material paste layer being formed of the sealing material for the honeycomb structure.

104. The method according to claim 103, further comprising
bonding a plurality of the honeycomb fired bodies with an adhesive layer interposed therebetween to construct the ceramic block.

105. The method according to claim 103,
wherein
the inorganic compound in the sealing material for the honeycomb structure comprises at least one of alkali metal compounds and alkaline earth metal compounds.

106. The method according to claim 103,
wherein
the ion adsorbent in the sealing material for the honeycomb structure comprises at least one of silica adsorbents, alumina adsorbents, zeolite adsorbents, clay adsorbents, mesoporous adsorbents, polyvalent metal salts, and activated carbon.

107. The method according to claim 106,
wherein
the ion adsorbent in the sealing material for the honeycomb structure comprises a clay adsorbent.

108. The method according to claim 107,
wherein
the clay adsorbent comprises at least one of bentonite, activated white clay, and montmorillonite.

109. The method according to claim 107,
wherein
the clay adsorbent comprises at least one of kaolinite, acid clay, halloysite, sericite, and mica clay minerals.

110. The method according to claim 106,
wherein
the ion adsorbent in the sealing material for the honeycomb structure comprises at least one of a zeolite adsorbent and activated carbon.

111. The method according to claim 110,
wherein
the zeolite adsorbent comprises at least one of alminosilicate zeolite, metallosilicate zeolite, and aluminophosphate zeolite.

112. The method according to claim 106,
wherein
the ion adsorbent in the sealing material for the honeycomb structure comprises a polyvalent metal salt.

113. The method according to claim 112,
wherein
the polyvalent metal salt comprises at least one of aluminum phosphate, iron phosphate, magnesium phosphate, and aluminum fluoride.

114. The method according to claim 106,
wherein
the ion adsorbent in the sealing material for the honeycomb structure comprises a silica adsorbent, and
the silica adsorbent comprises at least one of silica gel, aero gel, colloidal silica, and porous silicate glass.

115. The method according to claim 106,
wherein
the ion adsorbent in the sealing material for the honeycomb structure comprises an almina adsorbent, and
the almina adsorbent comprises an activated alumina.

116. The method according to claim 115,
wherein
the activated alumina comprises at least one of α-alumina, γ-alumina, δ-alumina, and θ-alumina.

117. The method according to claim 106,
wherein
the ion adsorbent in the sealing material for the honeycomb structure comprises a mesoporous adsorbent, and
the mesoporous adsorbent comprises at least one of mesoporous silica, mesoporous silica-alumina, mesoporous titania, and mesoporous zirconia.

118. The method according to claim 103,
wherein
the amount of the ion adsorbent in the sealing material for the honeycomb structure is about 0.2% by weight or more.

119. The method according to claim 103,
wherein
the amount of the ion adsorbent in the sealing material for the honeycomb structure is about 5.0% by weight or less.

120. The method according to claim 103,
wherein
the ion adsorbent in the sealing material for the honeycomb structure comprises at least one of a bentonite and a zeolite adsorbent, and
a content of the ion adsorbent in the sealing material for the honeycomb structure is from about 0.2% by weight to about 2.0% by weight.

121. The method according to claim 103,
wherein
the ion adsorbent in the sealing material for the honeycomb structure comprises an aluminum phosphate, and
a content of the ion adsorbent in the sealing material for the honeycomb structure is from about 0.1% by weight to about 2.0% by weight.

122. The method according to claim 103,
wherein
a weight ratio of the ion adsorbent to the inorganic fibers (weight of inorganic fibers/weight of ion adsorbent) in the sealing material for the honeycomb structure is from about 100/1 to about 4/1.

123. The method according to claim 103,
wherein
an average fiber length of the inorganic fibers in the sealing material for the honeycomb structure is from about 0.1 μm to about 1000 μm.

124. The method according to claim 103,
wherein
an amount of silica contained in the inorganic fibers in the sealing material for the honeycomb structure is from about 60% by weight to about 85% by weight.

125. The method according to claim 103,
wherein
an amount of Al₂O₃ contained in the inorganic fibers in the sealing material for the honeycomb structure is about 2% by weight or less.

126. The method according to claim 103,
wherein
an amount of the inorganic fibers contained in the sealing material for the honeycomb structure is from about 10% by weight to about 70% by weight.

127. The method according to claim 103,
wherein
an average particle diameter of the inorganic particles in the sealing material for the honeycomb structure is from about 0.01 μm to about 100 μm.

128. The method according to claim 105,
wherein
the alkali metal compounds in the sealing material for the honeycomb structure comprise at least one of sodium oxides, sodium salts, potassium oxides, and potassium salts, and
the alkaline earth metal compounds in the sealing material for the honeycomb structure comprise at least one of magnesium oxides, magnesium salts, calcium oxides, calcium salts, barium oxides, and barium salts.

129. The method according to claim 103,
wherein
the sealing material for the honeycomb structure further comprises an oxide sol.

130. The method according to claim 129,
wherein
the oxide sol comprises at least one of silica sol, alumina sol, and zirconia sol.

131. The method according to claim 129,
wherein
an amount of the oxide sol contained in the sealing material for the honeycomb structure is from about 1% by weight to about 30% by weight as a solid content.

132. The method according to claim 129,
wherein
an average particle diameter of the oxide included in the oxide sol is from about 5 nm to about 30 nm.

133. The method according to claim 129,
wherein
the sealing material for the honeycomb structure is alkaline.

134. The method according to claim 103,
wherein
the sealing material for the honeycomb structure is acidic.

135. The method according to claim 103,
wherein
a pH value of the sealing material for the honeycomb structure is from about 4 to about 7.

136. The method according to claim 104, further comprising solidifying an adhesive to form the adhesive layer.

137. The method according to claim 136,
wherein
the adhesive comprises a sealing material for the honeycomb structure, the sealing material for the honeycomb structure comprising:
inorganic fibers comprising a biosoluble inorganic compound;
inorganic particles; and
an ion adsorbent in an amount of about 0.1% by weight or more.

138. The method according to claim 137,
wherein
the inorganic compound in the adhesive comprises at least one of alkali metal compounds and alkaline earth metal compounds.

139. The method according to claim 137,
wherein
the ion adsorbent in the adhesive comprises at least one of silica adsorbents, alumina adsorbents, zeolite adsorbents, clay adsorbents, mesoporous adsorbents, polyvalent metal salts, and activated carbon.

140. The method according to claim 139,
wherein
the ion adsorbent in the adhesive comprises a clay adsorbent.

141. The method according to claim 140,
wherein
the clay adsorbent comprises at least one of bentonite, activated white clay, and montmorillonite.

142. The method according to claim 140,
wherein
the clay adsorbent comprises at least one of kaolinite, acid clay, halloysite, sericite, and mica clay minerals.

143. The method according to claim 139,
wherein
the ion adsorbent in the adhesive comprises at least one of a zeolite adsorbent and activated carbon.

144. The method according to claim 143,
wherein
the zeolite adsorbent comprises at least one of alminosilicate zeolite, metallosilicate zeolite, and aluminophosphate zeolite.

145. The method according to claim 139,
wherein
the ion adsorbent in the adhesive comprises a polyvalent metal salt.

146. The method according to claim 145,
wherein
the polyvalent metal salt comprises at least one of aluminum phosphate, iron phosphate, magnesium phosphate, and aluminum fluoride.

147. The method according to claim 139,
wherein
the ion adsorbent in the adhesive comprises a silica adsorbent, and
the silica adsorbent comprises at least one of silica gel, aero gel, colloidal silica, and porous silicate glass.

148. The method according to claim 139,
wherein
the ion adsorbent in the adhesive comprises an almina adsorbent, and
the almina adsorbent comprises an activated alumina.

149. The method according to claim 148,
wherein
the activated alumina comprises at least one of α-alumina, γ-alumina, δ-alumina, and θ-alumina.

150. The method according to claim 139,
wherein
the ion adsorbent in the adhesive comprises a mesoporous adsorbent, and
the mesoporous adsorbent comprises at least one of mesoporous silica, mesoporous silica-alumina, mesoporous titania, and mesoporous zirconia.

151. The method according to claim 137,
wherein
the amount of the ion adsorbent in the adhesive is about 0.2% by weight or more.

152. The method according to claim 137,
wherein
the amount of the ion adsorbent in the adhesive is about 5.0% by weight or less.

153. The method according to claim 137,
wherein
the ion adsorbent in the adhesive comprises at least one of a bentonite and a zeolite adsorbent, and
a content of the ion adsorbent in the adhesive is from about 0.2% by weight to about 2.0% by weight.

154. The method according to claim 137,
wherein
the ion adsorbent in the adhesive comprises an aluminum phosphate, and
a content of the ion adsorbent in the adhesive is from about 0.1% by weight to about 2.0% by weight.

155. The method according to claim 137,
wherein
a weight ratio of the ion adsorbent to the inorganic fibers (weight of inorganic fibers/weight of ion adsorbent) in the adhesive is from about 100/1 to about 4/1.

156. The method according to claim 137,
wherein
an average fiber length of the inorganic fibers in the adhesive is from about 0.1 μm to about 1000 μm.

157. The method according to claim 137,
wherein
an amount of silica contained in the inorganic fibers in the adhesive is from about 60% by weight to about 85% by weight.

158. The method according to claim 137,
wherein
an amount of Al₂O₃ contained in the inorganic fibers in the adhesive is about 2% by weight or less.

159. The method according to claim 137,
wherein
an amount of the inorganic fibers contained in the adhesive is from about 10% by weight to about 70% by weight.

160. The method according to claim 137,
wherein
an average particle diameter of the inorganic particles in the adhesive is from about 0.01 μm to about 100 μm.

161. The method according to claim 138,
wherein
the alkali metal compounds in the adhesive comprise at least one of sodium oxides, sodium salts, potassium oxides, and potassium salts, and
the alkaline earth metal compounds in the adhesive comprise at least one of magnesium oxides, magnesium salts, calcium oxides, calcium salts, barium oxides, and barium salts.

162. The method according to claim 137,
wherein
the adhesive further comprises an oxide sol.

163. The method according to claim 162,
wherein
the oxide sol comprises at least one of silica sol, alumina sol, and zirconia sol.

164. The method according to claim 162,
wherein
an amount of the oxide sol contained in the adhesive is from about 1% by weight to about 30% by weight as a solid content .

165. The method according to claim 162,
wherein
an average particle diameter of the oxide included in the oxide sol is from about 5 nm to about 30 nm.

166. The method according to claim 162,
wherein
the adhesive is alkaline.

167. The method according to claim 137,
wherein
the adhesive is acidic.

168. The method according to claim 137,
wherein
a pH value of the adhesive is from about 4 to about 7.

169. The method according to claim 103,
wherein
the ceramic block comprises a single honeycomb fired body.

170. The method according to claim 103, further comprising supporting a catalyst on the honeycomb structure.

171. The method according to claim 103,
wherein
either one end portion of each of the through holes is plugged.

172. The method according to claim 103,
wherein
an end portion of each of the through holes is not plugged.

173. The method according to claim 104, further comprising,
applying an adhesive including the sealing material for the honeycomb structure on a predetermined side surface of each of the honeycomb fired bodies to form an adhesive paste layer,
placing other honeycomb fired bodies on the adhesive paste layer, and
solidifying the adhesive paste layer to form the adhesive layer.

174. The method according to claim 104, further comprising,
placing a plurality of honeycomb fired bodies in parallel with one another in columns and rows with a spacer interposed therebetween so as to form a parallel-arranged body of honeycomb fired bodies having a gap between the honeycomb fired bodies,
filling the gap with the sealing material for the honeycomb structure by using a filling apparatus to manufacture a laminated body of the honeycomb fired bodies, and
heating the laminated body of the honeycomb fired bodies to dry and solidify the sealing material for the honeycomb structure so that the adhesive layer is formed.

175. The method according to claim 104, further comprising,
placing multiple kinds of honeycomb fired bodies having mutually different cross-sectional shapes in parallel with one another in columns and rows with a spacer interposed therebetween so as to form a parallel-arranged body of honeycomb fired bodies having a gap between the honeycomb fired bodies,
disposing the parallel-arranged body of honeycomb fired bodies inside a filling apparatus having a tubiform so as to form a gap between the honeycomb fired body and the tubiform,
filling both the gap between the honeycomb fired bodies and the gap between the honeycomb fired body and the tubiform with the sealing material for the honeycomb structure, and
solidifying the sealing material for the honeycomb structure so that the adhesive layer between the honeycomb fired bodies and the peripheral sealing material layer are simultaneously formed.

176. The method according to claim 103, further comprising, cutting a periphery of the ceramic block.
